(19) United States
(12) Patent Application Publication
(10) Pub. No.: US 2013/0100920 A1
(43) Pub. Date: Apr. 25, 2013

(54) WIRELESS COMMUNICATION SYSTEM, RECEPTION APPARATUS, RECEPTION CONTROL METHOD, RECEPTION CONTROL PROGRAM, AND PROCESSOR

(71) Applicants: Osamu Nakamura, Osaka-shi (JP); Katsuya Kato, Osaka-shi (JP); Hiromichi Tomeba, Osaka-shi (JP); Jungo Goto, Osaka-shi (JP); Kazunari Yokomakura, Osaka-shi (JP); Yasuhiro Hamaguchi, Osaka-shi (JP)

(72) Inventors: Osamu Nakamura, Osaka-shi (JP); Katsuya Kato, Osaka-shi (JP); Hiromichi Tomeba, Osaka-shi (JP); Jungo Goto, Osaka-shi (JP); Kazunari Yokomakura, Osaka-shi (JP); Yasuhiro Hamaguchi, Osaka-shi (JP)

(73) Assignee: SHARP KABUSHIKI KAISHA, Osaka-shi, Osaka (JP)

(21) Appl. No.: 13/806,598

(22) PCT Filed: Jun. 28, 2011
(86) PCT No.: PCT/JP2011/064800

§ 371 Date: Dec. 21, 2012

(30) Foreign Application Priority Data
Jun. 28, 2010 (JP) 2010-146881

(51) Int. Cl. H04W 72/04

(52) U.S. Cl. CPC H04W 72/04
USPC 370/329

(57) ABSTRACT

A mobile station apparatus receives the same spectra that have been transmitted from at least one first transmit antenna and a second transmit antenna. An equalization unit performs, for each of the same spectra, using spectra of subcarriers having the same spectrum placed therein, equalization of the spectrum.

### TECHNICAL FIELD

The present invention relates to a wireless communication system, a reception apparatus, a reception control method, a reception control program, and a processor.

Priority is claimed on Japanese Patent Application No. 2010-146881, filed Jun. 28, 2010, the content of which is incorporated herein by reference.

### BACKGROUND ART

In LTE (Long Term Evolution, a 3.9G wireless access technology), which is a wireless communication standard of 3GPP (3rd Generation Partnership Project), and in LTE-A (LTE-Advanced), which is an advanced version of LTE, OFDMA (Orthogonal Frequency Division Multiple Access) that has high tolerance of frequency selective channels and that has high affinity with MIMO (Multiple Input Multiple Output) transmission has been employed as a transmission scheme for downlinks (wireless communication lines from base station apparatuses to mobile station apparatuses). Meanwhile, in a transmission scheme for uplinks (wireless communication lines from the mobile station apparatuses to the base station apparatuses), the cost and size of the mobile station apparatuses are important. For example, the mobile station apparatuses are sold to and utilized by the general public users. Accordingly, it is difficult to build, into the mobile station apparatuses, for example, circuits which are expensive, or whose dimensions are large or whose weight is large.

However, in multi-carrier transmission such as OFDMA or MC-CDMA (Multi-Carrier Code Division Multiple Access), a power amplifier that realizes a high PAPR (Peak to Average Power Ratio) for a transmission signal and that has a large linear region is necessary for the mobile station apparatuses. Accordingly, such multi-carrier transmission is not suitable for uplink transmission in which the size and cost of terminal apparatuses are problems.

In other words, in order to maintain a wide coverage (a communication coverage range, for example, distances to the base station apparatuses) in uplinks, single-carrier transmission in which the PAPR is low is preferable. Also in LTE, SC-FDMA (Single Carrier Frequency Division Multiple Access, also referred to as DFT-S-OFDM) is employed for uplinks. In other words, in LTE, different transmission schemes are employed, i.e., single-carrier transmission is employed for uplinks and multi-carrier transmission is employed for downlinks.

Furthermore, in the case where a transmission apparatus has multiple transmit antennas in the case of wireless communication, the transmission apparatus transmits, signals independent of one another at the same time at the same frequencies from the individual transmit antennas, whereby the transmission speed can be increased. This technique is called spatial multiplexing transmission, and the number of signals simultaneously transmitted is called the number of streams, the number of ranks, or the number of layers. The signals transmitted from the individual antennas are demultiplexed by a signal demultiplexing process such as special filtering or MLD (Maximum Likelihood Detection) in a reception apparatus.

Moreover, the individual transmit antennas have different frequencies at which the channel characteristics are excellent. Regarding this, it is described in PTL 1 and PTL 2 that transmission is performed using allocation of frequencies which is different for each transmit antenna.

### CITATION LIST

### Patent Document

[Patent Document 1] Japanese Unexamined Patent Application Publication No. 2008-199598
[Patent Document 2] WO/2009/022709

### DISCLOSURE OF INVENTION

### Problems to be Solved by the Invention

However, in transmit antenna diversity in which signals representing the same data are transmitted from the individual transmit antennas of the transmission apparatus, when different allocations of frequencies are allowed, different spectra are transmitted at each of the frequencies. Thus, interference in signals received by the reception apparatus occurs, and there is a disadvantage that the reception quality deteriorates.

The present invention has been made in view of the above-described issues, and provides a wireless communication system, a reception apparatus, a reception control method, a reception control program, and a process that can improve the reception quality in a reception apparatus.

### Means for Solving the Problems

(1) The present invention has been made in order to solve the above-mentioned problem, according to an aspect of the present invention, there is provided a wireless communication system including: a transmission apparatus that transmits spectra from at least one first transmit antenna, and that transmits, from a second transmit antenna, spectra which are the same as the spectra; and a reception apparatus that receives the same spectra transmitted from the first and second transmit antennas. The transmission apparatus includes a mapping unit that places the spectra for each of the transmit antennas. The reception apparatus includes an equalization unit that performs, for each of the same spectra, using spectra of subcarriers having the same spectrum placed therein, equalization of the spectrum.

(2) Furthermore, according to an aspect of the present invention, in the wireless communication system, the mapping unit places the spectra so that allocation of a frequency band is different for each of the first transmit antenna and the second transmit antenna.

(3) Moreover, according to an aspect of the present invention, in the wireless communication system, the mapping unit places the spectra so that allocation of frequencies to the individual spectra is different for each of the first transmit antenna and the second transmit antenna.

(4) Additionally, according to an aspect of the present invention, in the wireless communication system, the transmission apparatus further includes a rearranging unit that rearranges the spectra so that an order of the spectra is different for each of the first transmit antenna and the second transmit antenna. The mapping unit places the spectra in the order of the spectra rearranged by the rearranging unit.

(5) Furthermore, according to an aspect of the present invention, in the wireless communication system, the equalization unit performs, using spectra of subcarriers having the same spectrum placed therein and spectra of subcarriers having spectra, which is the same as the spectra, placed therein, equalization of the spectrum.

(6) Moreover, according to an aspect of the present invention, in the wireless communication system, the wireless communication system includes a transmission apparatus having the first transmit antenna and a transmission apparatus having the second transmit antenna.

(7) Additionally, according to an aspect of the present invention, in the wireless communication system, the reception apparatus further includes a demapping unit that extracts, for each of the same spectra, spectra of subcarriers having the same spectrum placed therein. The equalization unit performs, using the spectra extracted by the demapping unit, equalization of the spectrum.

(8) Furthermore, according to an aspect of the present invention, in the wireless communication system, the reception apparatus further includes a channel-matrix generation unit that generates, for each of the same spectra, a channel matrix for subcarriers having the spectrum placed therein. The equalization unit performs, using the channel matrix generated by the channel-matrix generation unit, equalization of the spectrum.

(9) Moreover, according to an aspect of the present invention, in the wireless communication system, the equalization unit switches, in accordance with whether or not subcarriers having the same spectrum placed therein have another spectrum placed therein, a process of computing a weight that is to be used in equalization.

(10) Additionally, according to an aspect of the present invention, there is provided a reception apparatus that receives the same spectra transmitted from at least one first transmit antenna and a second transmit antenna. The reception apparatus includes an equalization unit that performs, for each of the same spectra, using spectra of subcarriers having the same spectrum placed therein, equalization of the spectrum.

(11) Furthermore, according to an aspect of the present invention, there is provided a reception control method for a reception apparatus that receives the same spectra transmitted from at least one first transmit antenna and a second transmit antenna. The reception control method includes an equalization step of performing, with the reception apparatus, for each of the same spectra, using spectra of subcarriers having the same spectrum placed therein, equalization of the spectrum.

(12) Moreover, according to an aspect of the present invention, there is provided a reception control program for causing a computer of a reception apparatus that receives the same spectra transmitted from at least one first transmit antenna and a second transmit antenna to execute equalization means for performing, for each of the same spectra, using spectra of subcarriers having the same spectrum placed therein, equalization of the spectrum.

(13) Additionally, according to an aspect of the present invention, there is provided a processor that performs, for each of the same spectra transmitted from at least one first transmit antenna and a second transmit antenna, using spectra of subcarriers having the same spectrum placed therein, equalization of the spectrum.

(14) Furthermore, according to an aspect of the present invention, there is provided a processor that extracts, for each of the same spectra transmitted from at least one first transmit antenna and a second transmit antenna, spectra of subcarriers having the same spectrum placed therein.

(15) Moreover, according to an aspect of the present invention, there is provided a processor that generates, for each of the same spectra transmitted from at least one first transmit antenna and a second transmit antenna, a channel matrix for subcarriers having the same spectrum placed therein.

### Effects of the Invention

According to the present invention, the wireless communication system can improve the reception quality in the reception apparatus.

### BRIEF DESCRIPTION OF THE DRAWINGS

FIG. 1 is a schematic diagram illustrating an example of a wireless communication system according to a first embodiment of the present invention.

FIG. 2 is a schematic block diagram illustrating a configuration of a base station apparatus according to the present embodiment.

FIG. 3 is a schematic diagram illustrating an example of allocation information according to the present embodiment.

FIG. 4 is a schematic diagram illustrating an example of allocation of frequency spectra according to the present embodiment.

FIG. 5 is a schematic diagram illustrating another example of allocation of the frequency spectra according to the present embodiment.

FIG. 6 is a schematic diagram illustrating another example of allocation of the frequency spectra according to the present embodiment.

FIG. 7 is a schematic block diagram illustrating a configuration of a mobile station apparatus according to the present embodiment.

FIG. 8 is a schematic block diagram illustrating a configuration of an equalization unit according to the present embodiment.

FIG. 9 is a schematic diagram illustrating an example of a wireless communication system according to a second embodiment of the present invention.

FIG. 10 is a schematic block diagram illustrating a configuration of a mobile station apparatus according to the present embodiment.

FIG. 11 is a schematic diagram illustrating an example of allocation of frequency spectra according to the present embodiment.

FIG. 12 is a schematic diagram illustrating another example of allocation of the frequency spectra according to the present embodiment.

FIG. 13 is a schematic diagram illustrating another example of allocation of the frequency spectra according to the present embodiment.

FIG. 14 is a schematic block diagram illustrating a configuration of a base station apparatus according to the present embodiment.

FIG. 15 is a flowchart illustrating an example of a selection process for each of the signals, which is performed by a combining part according to the present embodiment.

FIG. 16 is a schematic block diagram illustrating a configuration of an equalization unit according to the present embodiment.

FIG. 17 is an explanatory diagram for explaining an effect of the wireless communication system according to the present embodiment.

FIG. 18 is a schematic block diagram illustrating a configuration of a mobile station apparatus according to a third embodiment of the present invention.

FIG. 19 is a schematic diagram illustrating an example of allocation information according to the present embodiment.

FIG. 20 is a schematic diagram illustrating signals that are input to a rearranging unit according to the present embodiment.

FIG. 21 is a schematic diagram illustrating examples of signals that are output from the rearranging unit according to the present embodiment.

FIG. 22 is a schematic diagram illustrating other examples of the signals that are output from the rearranging unit according to the present embodiment.

FIG. 23 is a schematic diagram illustrating an example of allocation of frequency spectra according to the present embodiment.

FIG. 24 is a schematic block diagram illustrating a configuration of a base station apparatus according to the present embodiment.

FIG. 25 is a schematic diagram illustrating an example of a wireless communication system according to a fourth embodiment of the present invention.

FIG. 26 is a schematic block diagram illustrating configurations of a central processing apparatus and a base station apparatus according to the present embodiment.

FIG. 27 is a schematic diagram illustrating an example of allocation information according to the present embodiment.

FIG. 28 is a schematic diagram illustrating an example of allocation of frequency spectra according to the present embodiment.

### BEST MODE FOR CARRYING OUT THE INVENTION

### First Embodiment

Hereinafter, embodiments of the present invention will be described in detail with reference to the drawings.

### <Regarding Wireless Communication System>

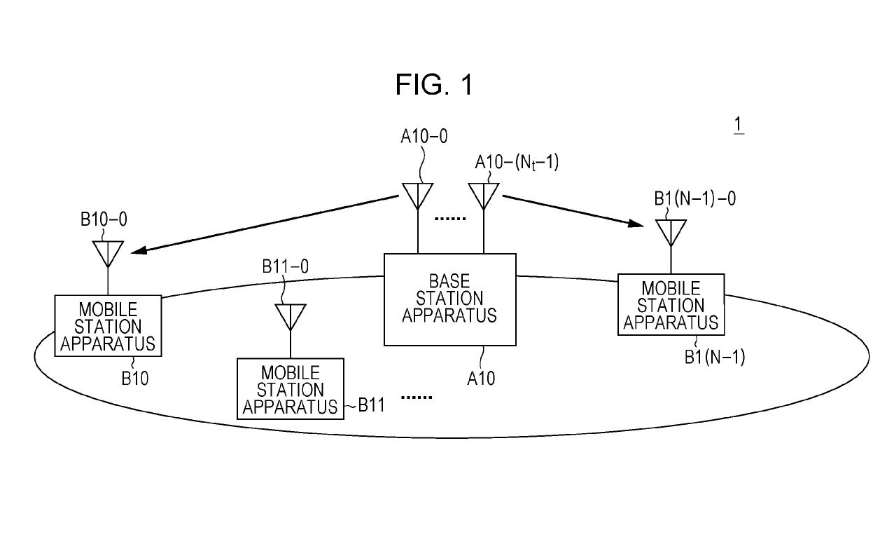

FIG. 1 is a schematic diagram illustrating an example of a wireless communication system 1 according to a first embodiment of the present invention. In this diagram, the wireless communication system 1 includes a base station apparatus A10 and N mobile station apparatuses B1n (n=0 to N−1).

In downlink communication from the base station apparatus A10 to the mobile station apparatuses B1n, OFDMA is used as a transmission scheme. The base station apparatus A10 has Nₜ transmit antennas A10-nₜ (nₜ=0 to Nₜ−1). The base station apparatus A10 transmits signals to the mobile station apparatuses B1n via the Nₜ transmit antennas. Note that, hereinafter, nₜ is also referred to as an “antenna number”.

Each of the mobile station apparatuses B1n has a receive antenna B1n-0, and receives signals transmitted by the base station apparatus A10. Note that, although the case where the mobile station apparatus B1n has one receive antenna B1n-0 is described in the present embodiment, the present invention is not limited thereto, and the mobile station apparatus B1n may have multiple receive antennas.

Hereinafter, the base station apparatus A10 is referred to as a base station apparatus a1, and each of the mobile station apparatuses B1n is referred to as a mobile station apparatus b1.

<Regarding Base Station Apparatus a1>

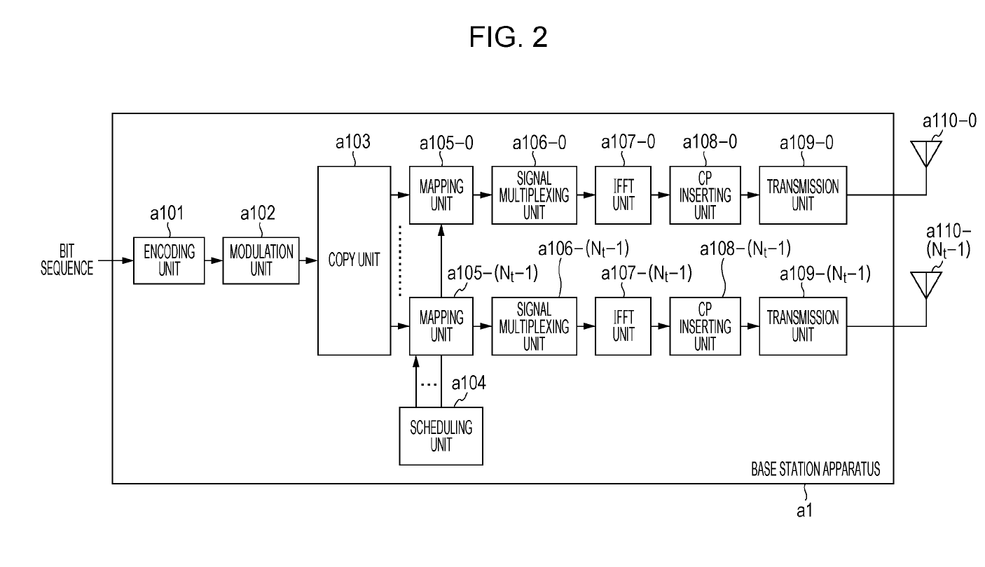

FIG. 2 is a schematic block diagram illustrating a configuration of the base station apparatus a1 according to the present embodiment. In this diagram, the base station apparatus a1 includes an encoding unit a101, a modulation unit a102, a copy unit a103, a scheduling unit a104, mapping units a105-nₜ (nₜ=0 to Nₜ−1), signal multiplexing units a106-nₜ, IFFT (Inverse Fast Fourier Transform) units a107-nₜ, CP (Cyclic Prefix) inserting units a108-nₜ, transmission units a109-nₜ, and transmit antennas a110-nₜ. Note that the base station apparatus a1 includes, in addition, typical and well-known functions of a base station apparatus. Furthermore, although the base station apparatus a1 in the case (transmission in which the number of ranks is “1”) where a signal representing the same data is transmitted from all of the transmit antennas a110-nₜ is illustrated in FIG. 2, the present invention is not limited thereto. The base station apparatus a1 may use transmission in which the number of ranks is lower than the number of transmit antennas. For example, in the case where nₜ=4, transmission in which the number of ranks is “3” may be used. Here, the number of ranks is the number of signals that are simultaneously transmitted.

A bit sequence, such as audio data, character data, or image data, is input to the encoding unit a101. The encoding unit a101 performs error correction coding on the input bit sequence, and outputs the error-correction-coded bits to the modulation unit a102.

The modulation unit a102 modulates the coded bits input from the encoding unit a101. The modulation unit a102 outputs, to the copy unit a103, in units of M pieces, signals that have been obtained by the modulation. Hereinafter, the output signals are denoted by s(m) (m=0 to M−1). Note that, in modulation performed by the modulation unit a102, a modulation scheme for modulation, such as QPSK (Quadrature Phase Shift Keying) or 16QAM (Quadrature Amplitude Modulation), is used.

The copy unit a103 copies (duplicates) the signals s(m) input from the modulation unit a102 to generate Nₜ, which is the number of transmit antennas, sets of the signals s(m). The copy unit a103 outputs each of the generated sets of the signals s(m) to a corresponding one of the mapping units a105-0 to a105-(Nₜ−1).

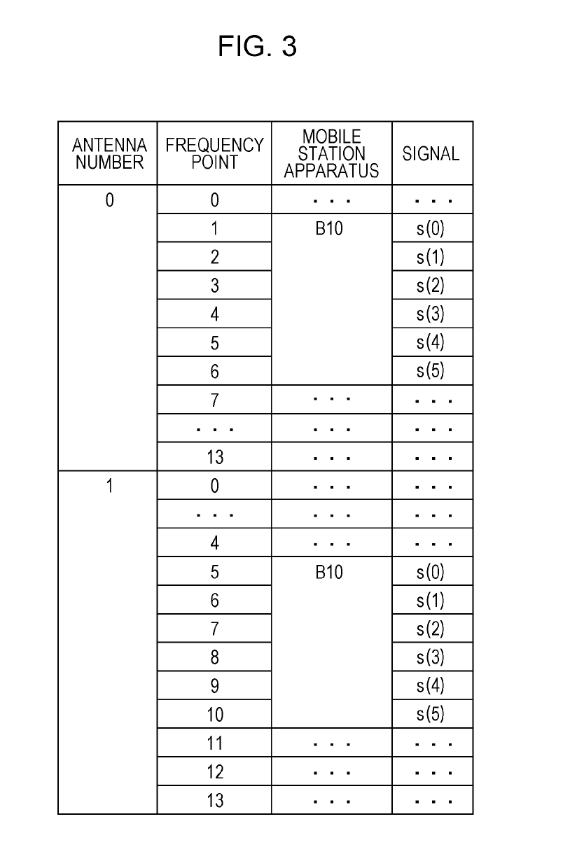

The scheduling unit a104 stores allocation information (e.g., an example illustrated in FIG. 3) indicating allocation of frequencies to the signals in the individual mapping units a105-nₜ. The allocation of frequencies indicated by the allocation information includes allocation of frequencies that is different for each of the mapping units a105-nₜ. Note that the allocation information may be information stored in advance through an operation performed by an operator or the like, or information determined by the base station apparatus a1 on the basis of a predetermined rule may be stored as the allocation information. The base station apparatus a1 may determine and update the allocation information on the basis of information (channel estimation values or the like), which has been notified from the mobile station apparatuses b1, concerning downlink channels. For example, the base station apparatus a1 determines the allocation information so that, for each of the transmit antennas a110-nₜ, a frequency at which the channel quality, which is indicated by the information concerning a channel, of a certain one of the mobile station apparatuses b1 is the highest is allocated to a signal for the mobile station apparatus b1. The scheduling unit a104 outputs the stored allocation information to the mapping units a105-nₜ.

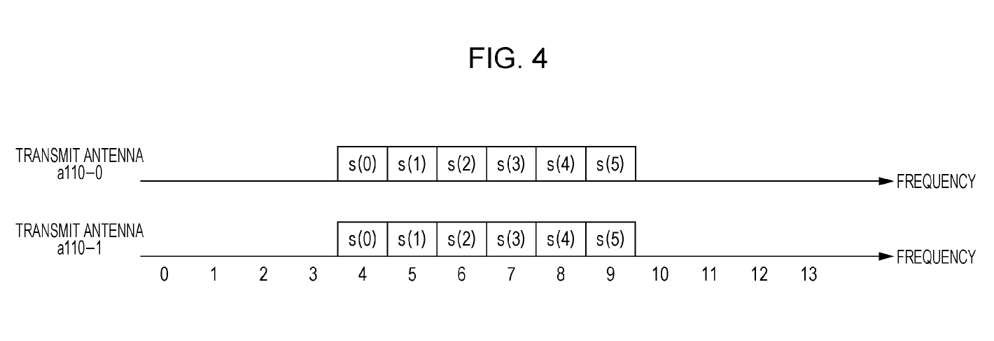

Each of the mapping units a105-nₜ places the signals s(m), which have been input from the copy unit a103, at frequencies indicated by the allocation information, which has been input from the scheduling unit a104. Specifically, the mapping unit a105-nₜ places the signals s(m) at m frequency points among frequency points p which are the frequency points p of frequencies indicated by the allocation information and which are to be used in inverse fast Fourier transform. Here, the signals s(m) placed by the mapping unit a105-nₜ are also referred to frequency spectra s(m) (see FIGS. 4 to 6), and M is also referred to as the “number of frequency spectra”. The mapping unit a105-nₜ places the signals whose destination is each of the mobile station apparatuses b1 at frequency points p among the N_{FFT} frequency points p of FFT intervals, and outputs the placed frequency spectra to a corresponding one of the signal multiplexing units a106-nₜ.

Each of the signal multiplexing units a106-nₜ multiplexes the frequency spectra (also referred to as data signals), which have been input from a corresponding one of the mapping units a105-nₜ, reference signals (which are equivalent to pilot symbols in the W-CDMA scheme or preamble signals in a wireless LAN) for performing estimation for channels between a corresponding one of the transmit antennas a110-nₜ and the receive antenna of a certain one of the mobile station apparatuses b1, the allocation information concerning allocation of the frequency spectra, the modulation scheme (the modulation scheme used by the modulation unit a102), or information concerning a coding rate (a coding rate used by the encoding unit a101), and control information such as a transmission mode, thereby generating a signal for transmission frames. The signal multiplexing unit a106-nₜ outputs the generated signal for transmission frames to a corresponding one of the IFFT units a107-nₜ.

Each of the IFFT units a107-nₜ performs inverse fast Fourier transform of the N_{FFT} points on the signal input from a corresponding one of the signal multiplexing units a106-nₜ, thereby converting the signal from a frequency-domain signal to a time-domain signal. The IFFT unit a107-nₜ outputs a signal, which has been obtained by the transform, to a corresponding one of the CP inserting units a108-nₜ.

Each of the CP inserting units a108-nₜ inserts, for each OFDM symbol, a CP into the signal input from a corresponding one of the IFFT units a107-nₜ. Here, a CP is obtained by duplicating a latter half, which corresponds to a predetermined time band, of the signal, and is equivalent to a guard time. The CP inserting unit a108-nₜ inserts the CP, which has been obtained by the duplication, at the beginning of the signal. The CP inserting unit a108-nₜ outputs, to a corresponding one of the transmission units a109-nₜ, the signal into which CPs have been inserted.

Each of the transmission units a109-nₜ performs, on the signal input from a corresponding one of the CP inserting units a108-nₜ, a D/A (digital-to-analog) conversion process, an analog filtering process, and a process of upconverting from a base band to a carrier frequency. The transmission unit a109-nₜ transmits, via a corresponding one of the transmit antennas a110-nₜ, the signal that has been subjected to the processes.

FIG. 3 is a schematic diagram illustrating an example of the allocation information according to the present embodiment. This diagram illustrates an example of allocation information in the case where the number of antennas Nₜ=2 and the number of frequency spectra M=6. As illustrated in the diagram, the allocation information has columns of individual items that are an antenna number nₜ, a frequency point p, a mobile station apparatus, and a signal. In the allocation information, for each antenna number nₜ and each frequency point p, a corresponding one of the signals s(m) that is to be placed at the frequency point p is associated with the antenna number nₜ and the frequency point p.

For example, FIG. 3 indicates that, the mapping unit a105-0 corresponding to the antenna number nₜ=0 places the signals s(0) to s(5) whose destination is the mobile station apparatus B10 illustrated in FIG. 1 at frequency points 1 to 6, respectively. Furthermore, FIG. 3 indicates that the mapping unit a105-1 corresponding to the antenna number nₜ=1 places the signals s(0) to s(5) whose destination is the mobile station apparatus B10 at frequency points 5 to 10, respectively.

In other words, the mapping units a105-0 and a105-1 place the spectra so that allocation of a frequency band is different for each of the transmit antenna a110-0 and the transmit antenna a110-1.

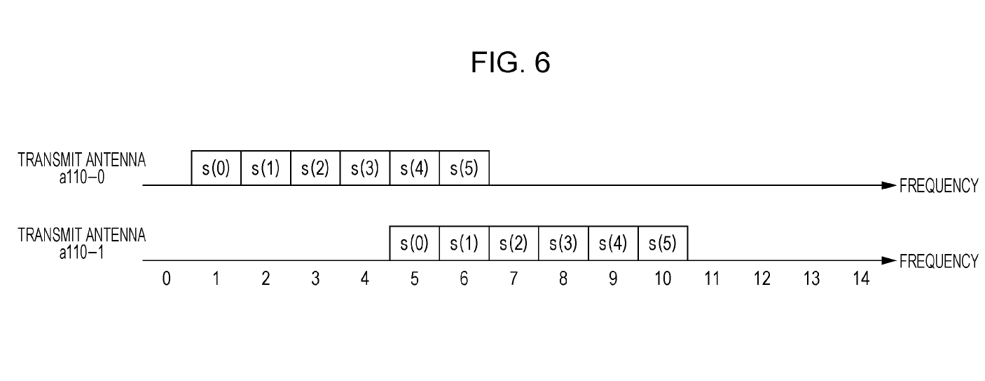

Note that FIG. 3 illustrates an example of the allocation information, and the allocation information according to the present embodiment may be different allocation information. For example, the order of p representing frequency point numbers and the order of m may be different from each other. Furthermore, the signals s(m) for a certain one of the mobile station apparatuses b1 may be not necessarily associated with p representing contiguous frequency point numbers, and may be associated with non-contiguous frequency point numbers. Moreover, in the case of the example illustrated in FIG. 3, the frequency spectra s(m) that are to be transmitted from the transmit antennas a110-0 and a110-1 are allocated as illustrated in FIG. 6.

Hereinafter, allocation of the frequency spectra s(m) for the individual transmit antennas a110-nₜ (the mapping units a105-nₜ) will be described using FIGS. 4 to 6. Note that FIGS. 4 to 6 illustrate examples of allocation information in the case where the number of transmit antennas Nₜ=2 and the number of frequency spectra M=6.

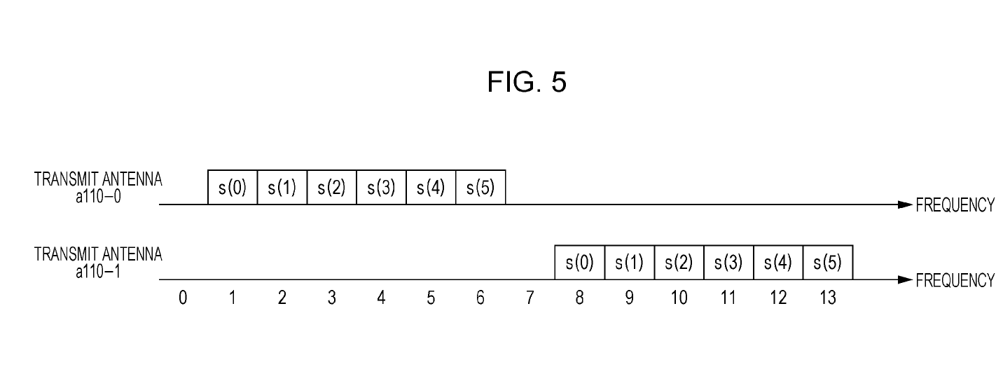

FIG. 4 is a schematic diagram illustrating an example of allocation of the frequency spectra s(m) according to the present embodiment. This diagram is a diagram for the case where Nₜ=2 (FIGS. 5 and 6 are also diagrams for the same case). FIG. 4 is a diagram for a case (a case of overlapping of all frequencies) where the scheduling unit a104 has allocated the frequency spectra s(m) so that, for the two transmit antennas a110-0 and a110-1, all frequencies to which the frequency spectra s(m) are allocated overlap each other.

In FIG. 4, for both of the transmit antennas a110-0 and a110-1, the frequency spectra s(0) to s(5) are allocated to the frequency points 4 to 9, respectively. In other words, the mapping units a105-0 and a105-1, which correspond to the antenna number nₜ=0 and the antenna number nₜ=1, respectively, place the signals s(0) to s(5) whose destination is a certain one of the mobile station apparatuses b at the frequency points 4 to 9, respectively.

FIG. 5 is a schematic diagram illustrating another example of allocation of the frequency spectra s(m) according to the present embodiment. FIG. 5 is a diagram for a case (a case of no overlapping of any frequencies) where the scheduling unit a104 has allocated the frequency spectra s(m) so that, for the two transmit antennas a110-0 and a110-1, frequencies to which the frequency spectra s(m) are allocated do not overlap each other at all.

In FIG. 5, for the transmit antenna a110-0, the frequency spectra s(0) to s(5) are allocated to the frequency points 1 to 6, respectively. Meanwhile, for the transmit antenna a110-1, the frequency spectra s(0) to s(5) are allocated to the frequency points 8 to 13, respectively. In other words, the mapping unit a105-0 places the signals s(0) to s(5) whose destination is a certain one of the mobile station apparatuses b1 at the frequency points 1 to 6, respectively. Meanwhile, the mapping unit a105-1 places the signals s(0) to s(5) whose destination is the mobile station apparatus b1 at the frequency points 9 to 13, respectively.

FIG. 6 is a schematic diagram illustrating another example of allocation of the frequency spectra s(m) according to the present embodiment. FIG. 6 is a diagram for a case (a case of partially overlapping) where the scheduling unit a104 has allocated the frequency spectra s(m) so that, for the two transmit antennas a110-0 and a110-1, only some frequencies to which the frequency spectra s(m) are allocated partially overlap each other (only some frequencies do not partially overlap each other) (see FIG. 6).

In FIG. 6, for the transmit antenna a110-0, the frequency spectra s(0) to s(5) are allocated to the frequency points 1 to 6, respectively. Meanwhile, for the transmit antenna a110-1, the frequency spectra s(0) to s(5) are allocated to the frequency points 5 to 10, respectively. In other words, the mapping unit a105-0 places the signals s(0) to s(5) whose destination is a certain one of the mobile station apparatuses b1 at the frequency points 1 to 6, respectively. Meanwhile, the mapping unit a105-1 places the signals s(0) to s(5) whose destination is the mobile station apparatus b1 at the frequency points 5 to 10, respectively.

As described above, in the example illustrated in FIG. 6, the frequency points 1 to 4 and 7 to 10, to which the frequency spectra s(m) are allocated, do not overlap each other, but the frequency points 5 and 6 overlap each other.

Note that, although, in FIGS. 4 to 6 described above, examples in which the scheduling unit a104 contiguously allocates the frequency spectra s(m) are illustrated, the scheduling unit a104 may non-contiguously allocate the frequency spectra s(m). Moreover, the number of frequency spectra M to be transmitted may be different for each of the antennas.

As described above, in the present embodiment, the base station apparatus a1 allocates, without restriction, the frequency spectra s(m) for the individual transmit antennas. Accordingly, the base station apparatus a1 can perform flexible allocation of frequencies using the gains of the individual transmit antennas. Note that the mapping units a105-nₜ according to the present embodiment may allocate, for a certain one of the mobile station apparatuses b1, zero to frequency points p to which the frequency spectra s(m) are not allocated, or may allocate, to the frequency points p, the frequency spectra s(m) for another one of the mobile station apparatuses b1.

As described above, signals transmitted from the base station apparatus a1 are received, via wireless channels, by the receive antennas of the mobile station apparatuses b1. Hereinafter, the mobile station apparatuses b1 will be described.

<Regarding Mobile Station Apparatus b1>

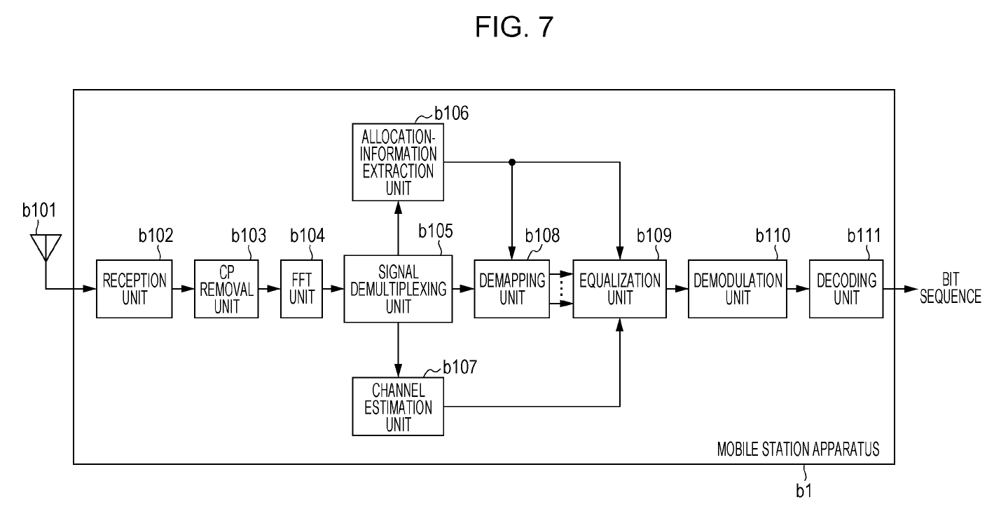

FIG. 7 is a schematic block diagram illustrating a configuration of each of the mobile station apparatuses b1 according to the present embodiment. In this diagram, the mobile station apparatus b1 includes a receive antenna b101, a reception unit b102, a CP removal unit b103, an FFT (Fast Fourier Transform) unit b104, a signal demultiplexing unit b105, an allocation-information extraction unit b106, a channel estimation unit b107, a demapping unit b108, an equalization unit b109, a demodulation unit b110, and a decoding unit bill. Note that the mobile station apparatus b1 includes, in addition, typical and well-known functions of a mobile station apparatus. Note that, although the number of receive antennas is “one” in the present embodiment, the present invention is not limited thereto. The mobile station apparatus b1 may include multiple receive antennas, and, using well-known techniques, may obtain a receive diversity gain or improve a capability of demultiplexing signals in MIMO.

The reception unit b102 performs, on signals received via the receive antenna b101, a process of downconverting from carrier frequencies to base band signals, an analog filtering process, and an A/D (analog-to-digital) conversion process. The reception unit b102 outputs, to the CP removal unit b103, the signals that have been subjected to the processes.

The CP removal unit b103 removes, for each OFDM symbol, a CP from the signals input from the reception unit b102. The CP removal unit b103 outputs the signals, from which CPs have been removed, to the FFT unit b104.

The FFT unit b104 performs fast Fourier transform of the N_{FFT} points on the signals input from the CP removal unit b103, thereby converting the signals from time-domain signals to frequency-domain signals. The FFT unit b104 outputs, to the signal demultiplexing unit b105, signals that have been obtained by the transform.

The signal demultiplexing unit b105 demultiplexes the signals, which have been input from the FFT unit b104, into reference signals, data signals, and control signals. The signal demultiplexing unit b105 outputs the control information, which has been obtained by the demultiplexing, to the allocation-information extraction unit b106, and outputs the data signals to the demapping unit b108. Furthermore, the signal demultiplexing unit b105 outputs the reference signals, which have been obtained by the demultiplexing, to the channel estimation unit b107.

The allocation-information extraction unit b106 extracts allocation information from the control information input from the signal demultiplexing unit b105, and outputs the allocation information to the demapping unit b108 and the equalization unit b109.

The channel estimation unit b107 obtains, using the reference signals input from the signal demultiplexing unit b105, channel estimation values (phases and amplitudes) for wireless channels between the individual transmit antennas a110-0 to a110-(Nₜ−1) of the base station apparatus a1 and the receive antenna b101. The channel estimation unit b107 outputs the obtained channel estimation values to the equalization unit b109.

The demapping unit b108 extracts, on the basis of the allocation information input from the allocation-information extraction unit b106, from the data signals (spectra) input from the signal demultiplexing unit b105, for each of s(m) (0≦m≦M−1) for which equalization is to be performed, signals r(p) of frequency points p at which s(m) has been transmitted.

Hereinafter, a selection process that is performed by the demapping unit b108 for each of the signals s(m) will be described using an example of the selection process for the signal s(1). Note that, although the selection process for the signal s(1) will be described below, the demapping unit b108 performs, similarly for the other signals s(m) (m≠1), the selection process for each or the signals s(m).

1) Case of example of allocation illustrated in FIG. 4 (case of overlapping of all frequencies)

The demapping unit b108 extracts a frequency point “5” at which the signal s(1) is placed, and selects a signal r(5) from the frequency point “5”.

2) Case of example of allocation illustrated in FIG. 5 (case of no overlapping of any frequencies)

The demapping unit b108 extracts frequency points “2” and “9” at which the signal s(1) is placed, and selects signals r(2) and r(9) from the frequency points “2” and “9”, respectively.

3) Case of example of allocation illustrated in FIG. 6 (allocation information illustrated in FIG. 3) (case of partially overlapping)

The demapping unit b108 extracts frequency points “2” and “6” at which the signal s(1) is placed, and selects signals r(2) and r(6) from the frequency points “2” and “6”, respectively.

Note that, in the selection process for each of the signals s(m), in the case of overlapping of all frequencies, the demapping unit b108 selects one signal r(p) for each of the signals s(0) to s(M−1). Meanwhile, in the case of no overlapping of any frequencies, the demapping unit b108 selects signals r(p), the number of signals r(p) being Nₜ/the number of ranks (Nₜ in the present embodiment) for each of the signals s(0) to s(M−1).

The demapping unit b108 outputs the extracted signals r(p) to the equalization unit b109.

The equalization unit b109 performs an equalization process on the signals r(p), which have been input from the demapping unit b108, on the basis of the allocation information, which has been input from the allocation-information extraction unit b106, and the channel estimation values, which have been input from the channel estimation unit b107. Note that the details of the equalization process will be described together with a configuration of the equalization unit b109. The equalization unit b109 outputs, to the demodulation unit b110, signals s′(m) that have been obtained by the equalization process.

The demodulation unit b110 demodulates, using a modulation scheme indicated by the control signals that have been obtained by demultiplexing performed by the signal demultiplexing unit b105, the signals input from the equalization unit b109. The demodulation unit b110 outputs, to the decoding unit b111, coded bits that have been obtained by demodulating the signals.

The decoding unit b111 performs error correction decoding on the coded bits, which have been input from the demodulation unit b110, on the basis of information concerning a coding rate indicated by the control signals have been obtained by demultiplexing performed by the signal demultiplexing unit b105. The decoding unit b111 outputs a decoded bit sequence.

<Regarding Equalization Unit b109>

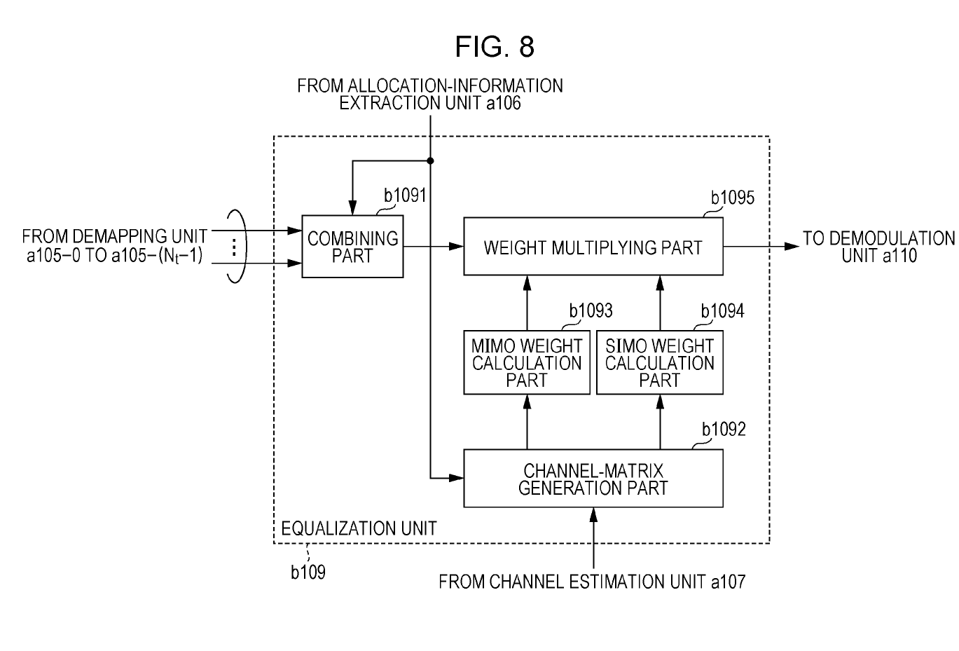

FIG. 8 is a schematic block diagram illustrating a configuration of the equalization unit b109 according to the present embodiment. In this diagram, the equalization unit b109 includes a combining part b1091, a channel-matrix generation part b1092, a MIMO weight calculation part b1093, a SIMO (Single Input Multiple Output) weight calculation part a1094, and a weight multiplying part b1095.

The combining part b1091 combines the signals r(p), which have been input from the demapping unit b108, for each of the signals s(m), on the basis of the allocation information input from the allocation-information extraction unit b106 to generate an Nₜ×1 (Nₜ rows by one column) vector Rₛ₍ₘ₎. The vector Rₛ₍ₘ₎ is represented, using the frequency spectra p (p₁, p₂, . . . , p_{N}_{ₜ}) selected by the demapping unit b108, by a vector having r(p₁) as a first element, r(p₂) as a second element, and r(p_{N}_{ₜ}) as an Nₜ-th element. The combining part b1091 inputs the vector Rₛ₍ₘ₎ to the weight multiplying part b1095.

The channel-matrix generation part b1092 generates, a channel matrix for each of the signals s(m) on the basis of the allocation information, which has been input from the allocation-information extraction unit b106, and the channel estimation values, which have been input from the channel estimation unit b107.

Specifically, the channel-matrix generation part b1092 selects, from the allocation information, the signals s(m) whose destination is the apparatus that is a subject of description, and extracts, for each of the selected signals s(m), antenna numbers nₜ and frequency points p that are associated with the signal. The channel-matrix generation part b1092 selects channel estimation values (denoted by Hₙₜ(p)) for the antenna numbers nₜ and the frequency points p that have been extracted for each of the signals s(m), and generates a channel matrix Hₛ₍ₘ₎ constituted by the selected channel estimation values Hₙₜ(p).

The channel-matrix generation part b1092 outputs the generated channel matrix Hₛ₍ₘ₎ to the MIMO weight calculation part b1093 or the SIMO weight calculation part b1094. Here, when the channel-matrix generation part b1092 determines that, in the allocation information, at all frequency points p associated with a signal s(m) of a certain m, another signal s(1) is not placed, the channel-matrix generation part b1092 outputs the channel matrix Hₛ₍ₘ₎ to the SIMO weight calculation part b1094. In contrast, when the channel-matrix generation part b1092 determines that, in the allocation information, at least one of frequency points p associated with a signal s(m) of a certain m, another signal s(1) is placed, the channel-matrix generation part b1092 outputs the channel matrix Hₛ₍ₘ₎ to the MIMO weight calculation part b1093.

For example, in the case of the allocation information illustrated in FIG. 3 (the allocation illustrated in FIG. 6), the channel-matrix generation part b1092 outputs a channel matrix Hₛ₍₁₎ to the MIMO weight calculation part b1093, and outputs a channel matrix Hₛ₍₃₎ to the SIMO weight calculation part b1094.

The MIMO weight calculation part b1093 calculates, using the channel matrix Hₛ₍ₘ₎ input from the channel-matrix generation part b1092, a MIMO weight vector wₛ₍ₘ₎ by using Expression (1) given below.

[Math. 1]

wₛ₍ₘ₎=[w(p₁) w(p₂) . . . w(p_{N}_{ₜ})]=hₛ₍ₘ₎^{H}(Hₛ₍ₘ₎Hₛ₍ₘ₎^{H}+σ²I)⁻¹ (1)

Here, hₛ₍ₘ₎ is a zeroth column vector of Hₛ₍ₘ₎, and X^{H} and X⁻¹ represent a Hermitian transpose process and an inverse-matrix computation process, respectively, of a matrix (a vector) X.

Furthermore, σ² is average noise power, and I is an Nₜ×Nₜ identity matrix. Note that the average noise power σ² is calculated by a noise estimation part (not illustrated), and is input to the MIMO weight calculation part b1093 and the SIMO weight calculation part b1094. Moreover, for example, the noise estimation part subtracts, for each of the frequencies, from a received signal corresponding to a reference signal in the frequency domain, a value obtained by multiplying the reference signal in the frequency domain by the channel estimation value for the frequency, and obtains the square of the absolute value of a subtraction result (noise). After that, the noise estimation part averages, using the number of frequencies, the obtained values, thereby calculating the average noise power σ².

The MIMO weight calculation part b1093 outputs the calculated MIMO weight vector wₛ₍ₘ₎ to the weight multiplying part b1095. Note that, although the MIMO weight calculation part b1093 calculates the MIMO weight vector Wₛ₍ₘ₎ by using Expression (1) using an MMSE (Minimum Mean Square Error) weight, the present invention is not limited thereto. For example, the MIMO weight calculation part b1093 may calculate the MIMO weight vector wₛ₍ₘ₎ by using a weight of another criterion such as ZF (Zero Forcing) in which the average noise power is not taken into consideration. Additionally, the equalization process performed by the equalization unit b109 may be a process using another signal demultiplexing method such as an iterative equalization process or MLD.

The SIMO weight calculation part b1094 calculates, using the channel matrix Hₛ₍ₘ₎ input from the channel-matrix generation part b1092, a SIMO weight vector wₛ₍ₘ₎ by using Expression (2) given below.

[Math. 2]

wₛ₍ₘ₎=hₛ₍ₘ₎^{H}=Hₛ₍ₘ₎^{H} (2)

The SIMO weight calculation part b1094 outputs the calculated SIMO weight vector w′ₛ₍ₘ₎ to the weight multiplying part b1095. Note that, although the SIMO weight calculation part b1094 calculates the SIMO weight vector wₛ₍ₘ₎ by using Expression (2) using an MRC (Maximum Ratio Combining) weight, the present invention is not limited thereto. For example, the SIMO weight calculation part b1094 may calculate the SIMO weight vector wₛ₍ₘ₎ by using a weight of another criterion such as ZF, EGC (Equal Gain Combining), or MMSE.

The weight multiplying part b1095 multiplies the signal vector Rₛ₍ₘ₎, which has been input from the combining part b1091, for each of the signals s(m) by the MIMO weight vector wₛ₍ₘ₎, which has been input from the MIMO weight calculation part b1093, or the SIMO weight vector w′ₛ₍ₘ₎, which has been input from the SIMO weight calculation part b1094. Accordingly, the mobile station apparatus b1 can obtain signals s′(m) corresponding to the signals s(m). The weight multiplying part b1095 outputs, to the demodulation unit b110, the signals s′(m) which have obtained by the multiplication by the weight vectors.

Hereinafter, examples of operations performed by the demapping unit b108 and the equalization unit b109 will be described using specific examples.

First, a case where, at least one of frequency points p associated with a signal s(m), another signal s(1) (1≠m) is placed will be described. For example, in the case of the allocation illustrated in FIG. 6 (the allocation information illustrated in FIG. 3), the signal s(1) is applicable to this case. Hereinafter, the details of a process will be described using the signal s(l).

The demapping unit b108 extracts, on the basis of the allocation information, the frequency points “2” and “6” at which the signal s(1) is placed. The demapping unit b108 selects the signals r(2) and r(6) that are placed at the frequency points “2” and “6”. The signals r(2) and r(6) are represented by Expression (3), which is given below, using the channel estimation values Hₙₜ(p) and the signals s(m).

$$\begin{matrix}[ Math . 3 ] & \\ \{ \begin{matrix}r ( 2 ) = {H}_{0} ( 2 ) s ( 1 ) \\ r ( 6 ) = {H}_{0} ( 6 ) s ( 5 ) + {H}_{1} ( 6 ) s ( 1 )\end{matrix} & ( 3 )\end{matrix}$$

Note that Expression (3) is an expression in the case where noise in the mobile station apparatus b1 and interference from other communication apparatuses is ignored. The received signals r(2) and r(6) extracted by the demapping unit b108 are input to the combining part b1091 included in the equalization unit b109. The combining part b1091 generates a vector Rₛ₍₁₎ having the signals r(2) and r(6) as elements. This vector Rₛ₍₁₎ is represented by Expression (4) given below.

$$\begin{matrix}[ Math . 4 ] & \\ \begin{matrix}{R}_{s ( 1 )} = [ \begin{matrix}r ( 2 ) \\ r ( 6 )\end{matrix} ] \\ = [ \begin{matrix}{H}_{0} ( 2 ) s ( 1 ) \\ {H}_{0} ( 6 ) s ( 5 ) + {H}_{1} ( 6 ) s ( 1 )\end{matrix} ] \\ = [ \begin{matrix}{H}_{0} ( 2 ) & 0 \\ {H}_{1} ( 6 ) & {H}_{0} ( 6 )\end{matrix} ] [ \begin{matrix}s ( 1 ) \\ s ( 5 )\end{matrix} ] \\ = {H}_{s ( 1 )} [ \begin{matrix}s ( 1 ) \\ s ( 5 )\end{matrix} ]\end{matrix} & ( 4 )\end{matrix}$$

Note that the third equation included in Expression (4) indicates that, for the signals transmitted from the transmit antenna a110-0 of the base station apparatus a1, a channel gain of the interference signal s(5) was zero at the frequency point “2”. Moreover, in the fourth equation included in Expression (3), a vector having the signals s(1) and s(5) as elements is multiplied by the channel matrix Hₛ₍ₘ₎.

The combining part b1091 outputs a vector Rₛ₍₁₎ to the weight multiplying part b1095.

Meanwhile, the channel-matrix generation part b1092 determines that the different signal s(5) is placed at least one of the frequency points “2” and “6” (the frequency point “6” in the present example) associated with the signal s(1), and outputs the channel matrix Hₛ₍₁₎ to the MIMO weight calculation part b1093. The MIMO weight calculation part b1093 calculates a MIMO weight vector wₛ₍₁₎ represented by Expression (5) given below.

[Math. 5]

wₛ₍₁₎=[w(2)w(6)]=hₛ₍₁₎^{H}(Hₛ₍₁₎Hₛ₍₁₎^{H}+σ²I)⁻¹ (5)

Here,

hₛ₍₁₎=[H₀(2)H₁(6)]^{Y} (6)

Here, a vector hₛ₍₁₎ is a zeroth column vector of Hₛ₍₁₎ in Expression (4), and XT represents a transpose process of a matrix (a vector) X.

As described above, in the case where, among multiple frequency points at which the same signal s(1) extracted by the demapping unit b108 has been transmitted (in the present example, s(1) has been transmitted at the frequency points “2” and “6”), there is interference from other signals at some frequency points, the equalization unit b109 generates a MIMO weight in which the interference is taken into consideration (in the present example, s(5) is interference at the frequency point “6”). Accordingly, the equalization unit b109 can efficiently obtain a transmit diversity gain.

The weight multiplying part b1095 multiplies the vector Rₛ₍₁₎, which has been input from the combining part b1091, by the MIMO weight vector Wₛ₍₁₎, which has been input from the MIMO weight calculation part b1093. A signal s′(m) that has been obtained by the multiplication is represented by Expression (7) given below.

[Math. 6]

s′(1)=wₛ₍₁₎Rₛ₍₁₎ (7)

Next, a case where, at all frequency points p associated with a signal s(m), another signal s(1) (1≠m) is not placed will be described. For example, in the case of the allocation illustrated in FIG. 6 (the allocation information illustrated in FIG. 3), the signal s(3) is applicable to this case. Hereinafter, the details of a process will be described using the signal s(3).

The demapping unit b108 extracts, on the basis of the allocation information, the frequency points “4” and “8” at which the signal s(3) is placed. The demapping unit b108 selects signals r(4) and r(8) that are placed at the frequency points “4” and “8”. The signals r(4) and r(8) are represented by Expression (8), which is given below, using the channel estimation values Hₙₜ(p) and the signals s(m).

$$\begin{matrix}[ Math . 7 ] & \\ \{ \begin{matrix}r ( 4 ) = {H}_{0} ( 4 ) s ( 3 ) \\ r ( 8 ) = {H}_{1} ( 8 ) s ( 3 )\end{matrix} & ( 8 )\end{matrix}$$

Note that Expression (8) is an expression in the case where noise in the mobile station apparatus b1 and interference from other communication apparatuses is ignored. The signals r(4) and r(8) extracted by the demapping unit b108 are input to the combining part b1091 included in the equalization unit b109. The combining part b1091 generates a vector Rₛ₍₃₎ having the signals r(4) and r(8) as elements. The vector Rₛ₍₃₎ is represented by Expression (9) given below.

$$\begin{matrix}[ Math . 8 ] & \\ \begin{matrix}{R}_{s ( 3 )} = [ \begin{matrix}r ( 4 ) \\ r ( 8 )\end{matrix} ] \\ = [ \begin{matrix}{H}_{0} ( 4 ) s ( 3 ) \\ {H}_{1} ( 8 ) s ( 3 )\end{matrix} ] \\ = [ \begin{matrix}{H}_{0} ( 4 ) \\ {H}_{1} ( 8 )\end{matrix} ] s ( 3 ) \\ = {H}_{s ( 3 )} s ( 3 )\end{matrix} & ( 9 )\end{matrix}$$

In the fourth equation included in Expression (9), the signal s(3) is multiplied by the channel matrix Hₛ₍ₘ₎. The combining part b1091 outputs the vector Rₛ₍₃₎ to the weight multiplying part b1095.

Meanwhile, the channel-matrix generation part b1092 determines that another signal s(1) (1≠3) is not placed at the frequency points “4” and “8” associated with the signal s(3), and outputs the channel matrix Hₛ₍₃₎ to the SIMO weight calculation part b1094. The SIMO weight calculation part b1094 calculates a SIMO weight vector w′ₛ₍₃₎ represented by Expression (10) given below.

[Math. 9]

w′ₛ₍₃₎=Hₛ₍₃₎^{H}=[H₀(4)H₁(8)]* (10)

Here, X* represents a complex conjugation process of a matrix (a vector) X. As described above, in the case where, among multiple frequency points at which the same signal s(3) has been transmitted (in the present example, s(3) has been transmitted at the frequency points “4” and “8”), there is no interference from another signal s(1) at any frequency point, the equalization unit b109 generates a SIMO weight in which the interference is not taken into consideration. Accordingly, the equalization unit b109 can efficiently obtain a transmit diversity gain by calculation that is easier than calculation of a MIMO weight.

The weight multiplying part b1095 multiplies the vector Rₛ₍₃₎, which has been input from the combining part b1091, by the SIMO weight vector w′ₛ₍₃₎, which has been input from the SIMO weight calculation part b1094. A signal s′(m) that has been obtained by the multiplication is represented by Expression (11) given below.

[Math. 10]

s′(3)=w′ₛ₍₃₎Rₛ₍₃₎ (11)

As examples of the operations performed by the demapping unit b108 and the equalization unit b109, the processes for the signals s(1) and s(3) in the case of the allocation illustrated in FIG. 6 are described above. Similarly, the equalization unit b109 performs processes for all of the signals s(m) (0≦m≦M−1).

As described above, in the case where a signal s(1) that interferes with a signal s(m) is present, the equalization unit b109 selects the MIMO weight calculation part b1094 that calculates a weight using inverse-matrix computation, and performs a process. In contrast, in the case where a signal s(1) that interferes with a signal s(m) is not present, the equalization unit b109 selects the SIMO weight calculation part b1093 that calculates a weight without using inverse-matrix computation, and performs a process. In other words, in accordance with whether or not, subcarriers having the same frequency spectrum s(m) placed therein have another frequency spectrum (1) (1≠m) placed therein, the equalization unit b109 switches a process of commutating a weight that is to be used in equalization.

Accordingly, the equalization unit b109 can perform the equalization process while preventing the amount of calculation from increasing.

Note that, for example, in the case of the allocation illustrated in FIG. 3(b), for all of the signals s(m), a signal s(1) that interferes with any one of the signals s(m) is not present. Thus, the equalization unit b109 selects only the SIMO weight calculation part b1094, and performs a process. In other words, the equalization unit b109 performs, in the above-described examples of the operations, a process similar to the process performed for the signal s(3).

As described above, according to the present embodiment, the demapping unit b108 extracts, for each of the same spectra, spectra of subcarriers having the same spectrum placed therein. The equalization unit b109 performs equalization of the spectrum using the spectra of the subcarriers which have been extracted by the demapping unit b108. Accordingly, in the case where the base station apparatus a1 transmits the same data from each of the multiple transmit antennas a110-nₜ, the transmission is not limited to transmission using the same frequencies. Transmission using frequencies that are different for each of the transmit antennas a110-nₜ can also be performed. Accordingly, for each of the transmit antennas a110-nₜ of the base station apparatus b1, transmission using a frequency at which the channel gain is high can be performed. Thus, power of received signals in the mobile station apparatus b1 can be improved. Furthermore, each of signals transmitted from the individual transmit antennas a110-nₜ is received at different frequencies in the mobile station apparatus b1. Accordingly, excellent transmission performances can be obtained by performing frequency combining in the equalization unit b109 of the mobile station apparatus b1.

### Second Embodiment

Hereinafter, a second embodiment of the present invention will be described in detail with reference to the drawings.

In the present embodiment, a case where a wireless communication system uses an SC-FDMA (Single Carrier Frequency Division Multiple Access, which is also referred to as DFT-S-OFDM (discrete-Fourier-transform-spread-OFDM)), which is single carrier transmission, will be described.

### <Regarding Wireless Communication System 2>

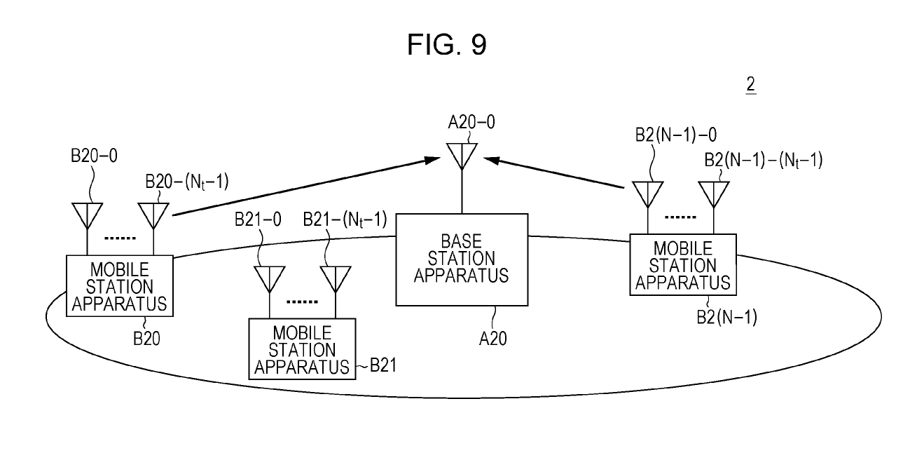

FIG. 9 is a schematic diagram illustrating an example of a wireless communication system 2 according to the second embodiment of the present invention. In this diagram, the wireless communication system 2 includes a base station apparatus A20 and N mobile station apparatuses B2n (n=0 to N−1).

In uplink communication from the mobile station apparatuses B2n to the base station apparatus A20, DFT-S-OFDM is used as a transmission scheme. Each of the mobile station apparatuses B2n has Nₜ transmit antennas B2n-nₜ (the antenna number, nₜ=0 to Nₜ−1). The mobile station apparatus B2n transmits signals to the base station apparatus A20 via the Nₜ transmit antennas. Here, the number of transmit antennas that each of the mobile station apparatuses B2n has may be different for each of the mobile station apparatuses.

The base station apparatus A20 has a receive antenna A20-0, and receives signals transmitted by the mobile station apparatuses B2n. Note that, although the case where the base station apparatus A20 has one receive antenna A2n-0 is described in the present embodiment, the present invention is not limited thereto, and the base station apparatus A20 may have multiple receive antennas.

Hereinafter, each of the mobile station apparatuses B2n is referred to as a mobile station apparatus b2, and the base station apparatus A20 is referred to as a base station apparatus a2.

<Regarding Mobile Station Apparatus b2>

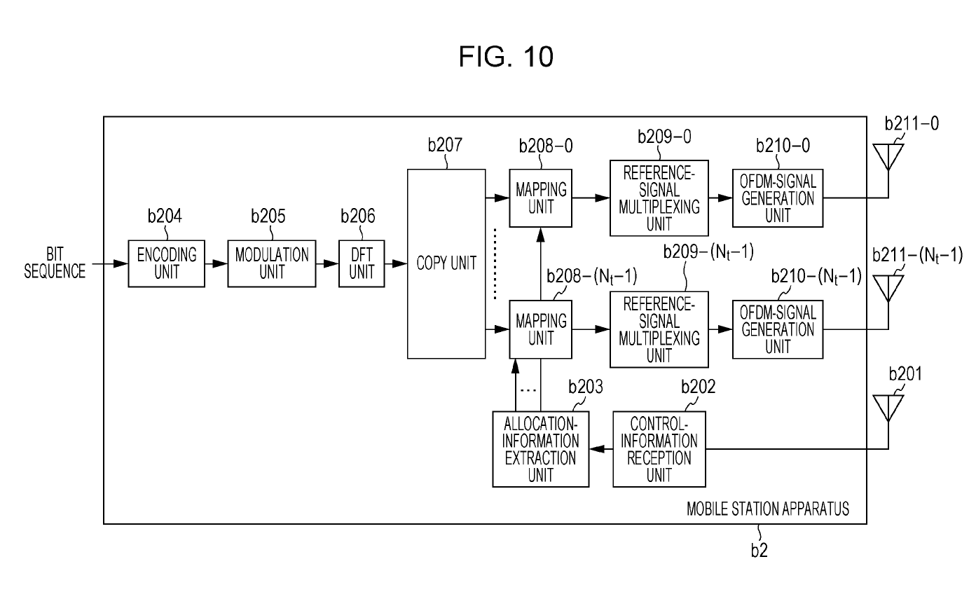

FIG. 10 is a schematic block diagram illustrating a configuration of each of the mobile station apparatuses b2 according to the present embodiment. In this diagram, the mobile station apparatus b2 includes a receive antenna b201 (not illustrated in FIG. 9), a control-information reception unit b202, an allocation-information extraction unit b203, an encoding unit b204, a modulation unit b205, a DFT (Discrete Fourier Transform) unit b206, a copy unit b207, mapping units b208-nₜ (nₜ=0 to Nₜ−1), reference-signal multiplexing units b209-nₜ, OFDM-signal generation units b210-nₜ, and transmit antennas b211-nₜ. Note that the mobile station apparatus b2 includes, in addition, typical and well-known functions of a mobile station apparatus.

The control-information reception unit b202 receives a signal from the base station apparatus a2 via the receive antenna b201, and demodulates and decodes the signal. The control-information reception unit b202 outputs, to the allocation-information extraction unit b203, control information out of the decoded information.

The allocation-information extraction unit b203 extracts allocation information (e.g., the example illustrated in FIG. 3) from the control information input from the control-information reception unit b202. The allocation information indicates allocation of frequencies to the signals in the individual mapping units b208-nₜ. The allocation-information extraction unit b203 outputs the extracted allocation information, for each of pieces of information concerning the antenna numbers nₜ, to a corresponding one of the mapping units b208-nₜ.

A bit sequence, such as audio data, character data, or image data, is input to the encoding unit b204. The encoding unit b204 performs error correction coding on the input bit sequence, and outputs the error-correction-coded bits to the modulation unit b205. Here, the encoding unit b204 performs error correction coding on the basis of a coding rate included in the control information out of the information decoded by the control-information reception unit b202.

The modulation unit b205 modulates the coded bits input from the encoding unit b204. The modulation unit b205 outputs, to the DFT unit b206, for each of N_{DFT} points, signals which have been obtained by the modulation. Note that, in the modulation performed by the modulation unit b205, a modulation scheme that is a modulation scheme for modulation, such as QPSK or 16QAM, and that is a modulation scheme for the control information out of the information decoded by the control-information reception unit b202 is used.

The DFT unit b206 performs discrete Fourier transform of the N_{DFT} points on the signals input from the modulation unit b205, thereby converting the signals from time-domain signals to frequency-domain signals. The DFT unit b206 outputs, to the copy unit b207, in units of N_{DFT} pieces, signals that have been obtained by the transform. Hereinafter, the output signals are denoted by s(m) (m=0 to N_{DFT}−1).

The copy unit b207 copies the signals s(m) input from the DFT unit b206 to generate Nₜ, which is the number of transmit antennas, sets of the signals s(m). The copy unit b207 outputs each of the generated sets of the signals s(m) to a corresponding one of the mapping units b208-0 to b208-(Nₜ−1).

Each of the mapping units b208-nₜ places the signals s(m), which have been input from the copy unit b207, at frequencies indicated by the allocation information input from the allocation-information extraction unit b203. Specifically, the mapping unit b208-nₜ places the signals s(m) at N_{DFT} frequency points that are assigned to the apparatus which is a subject of description among frequency points p that are the frequency points p of frequencies indicated by the allocation information and that are to be used in Fourier transform. For example, in the example illustrated in FIG. 3, the mapping unit b208-0 of the mobile station apparatus B10 places the signals s(m) at frequency points “1” to “6”. Here, N_{DFT} is also referred to as the “number of frequency spectra”. The mapping unit b208-nₜ outputs the placed signals s(m) to a corresponding one of the reference-signal multiplexing units b209-nₜ.

Each of the reference-signal multiplexing units b209-nₜ multiplexes the frequency spectra (also referred to as data signals), which have been input from a corresponding one of the mapping units b208-nₜ, reference signals (which are each also called SRS (Sounding Reference Signal)) that are used for the base station apparatus a2 reference signals (which are each also called (DMRS) DeModulation Reference Signal) to determine frequencies which are to be assigned to the mobile station apparatus b2, and that are used for the base station apparatus a2 to perform channel compensation, thereby generating a signal for transmission frames. Here, the reference-signal multiplexing unit b209-nₜ places the SRSs over an entire system band which is to be used in transmission, and places the DMRSs in a transmission band for the data signals. The reference-signal multiplexing unit b209-nₜ outputs the generated signal for transmission frames to a corresponding one of the OFDM-signal generation units b210-nₜ.

Each of the OFDM-signal generation units b210-nₜ performs IFFT of N_{FFT} points on the signal input from a corresponding one of the reference-signal multiplexing units b209-nₜ, thereby converting the signal from a frequency-domain signal to a time-domain signal (referred to as SC-FDMA symbols). The OFDM-signal generation unit b210-nₜ inserts CPs, which are equivalent to guard times, into the SC-FDMA symbols. The OFDM-signal generation unit b210-nₜ performs, on the SC-FDMA symbols into which CPs have been inserted, a D/A (digital-to-analog) conversion process, an analog filtering process, and a process of upconverting from a base band to a carrier frequency. The OFDM-signal generation unit b210-nₜ transmits, via a corresponding one of the transmit antennas b211-nₜ, the signal that has been subjected to the processes.

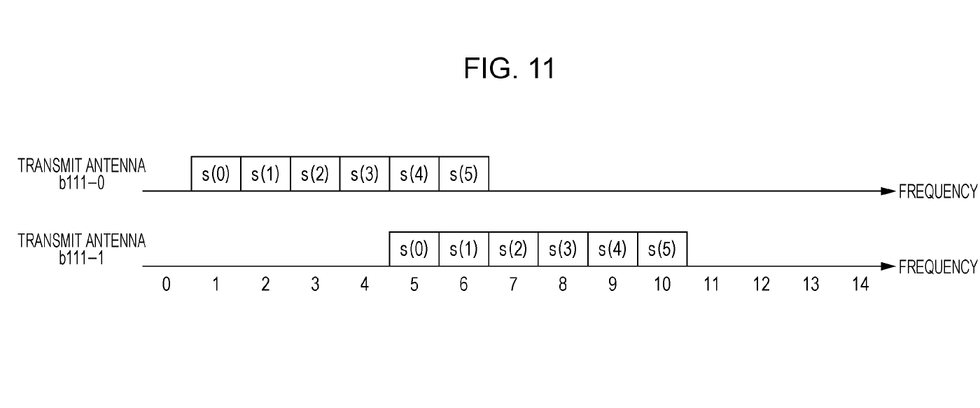

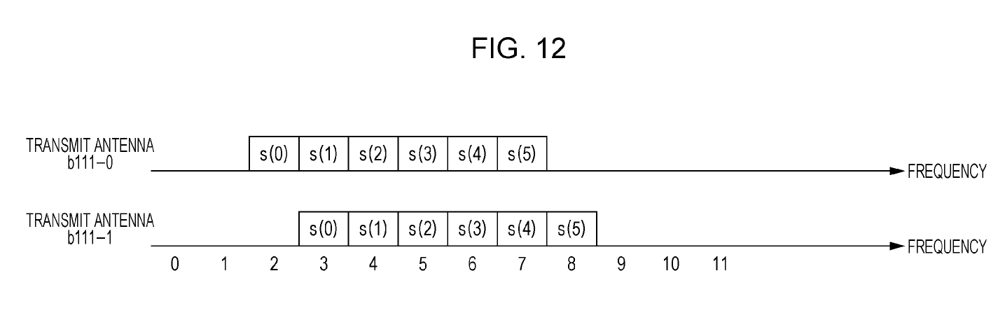

FIG. 11 is a schematic diagram illustrating an example of allocation of the frequency spectra according to the present embodiment. This diagram is also a diagram for the case where Nₜ=2 (FIG. 12 is also a diagram for the same case). Furthermore, this diagram illustrates allocation of the frequency spectra transmitted from the transmit antennas b211-0 and b211-1 in the case of the allocation information illustrated in FIG. 3.

In FIG. 11, for the transmit antenna b211-0, the frequency spectra s(0) to s(5) are allocated to the frequency points 1 to 6, respectively. Meanwhile, for the transmit antenna b211-1, the frequency spectra s(0) to s(5) are allocated to frequency points 5 to 10, respectively. In other words, the mapping unit b208-0, which corresponds to the antenna number nₜ=0, places the signals s(0) to s(5) at the frequency points 1 to 6, respectively. Meanwhile, the mapping unit b208-1, which corresponds to the antenna number nₜ=1, places the signals s(0) to s(5) at the frequency points 5 to 10, respectively.

FIG. 12 is a schematic diagram illustrating another example of allocation of the frequency spectra according to the present embodiment. In FIG. 12, for the transmit antenna b211-0, the frequency spectra s(0) to s(5) are allocated to the frequency points 2 to 7, respectively. Meanwhile, for the transmit antenna b211-1, the frequency spectra s(0) to s(5) are allocated to the frequency points 3 to 8, respectively. In other words, the mapping unit b208-0 places the signals s(0) to s(5) at the frequency points 1 to 6, respectively. Meanwhile, the mapping unit b208-1 places the signals s(0) to s(5) at the frequency points 3 to 8, respectively.

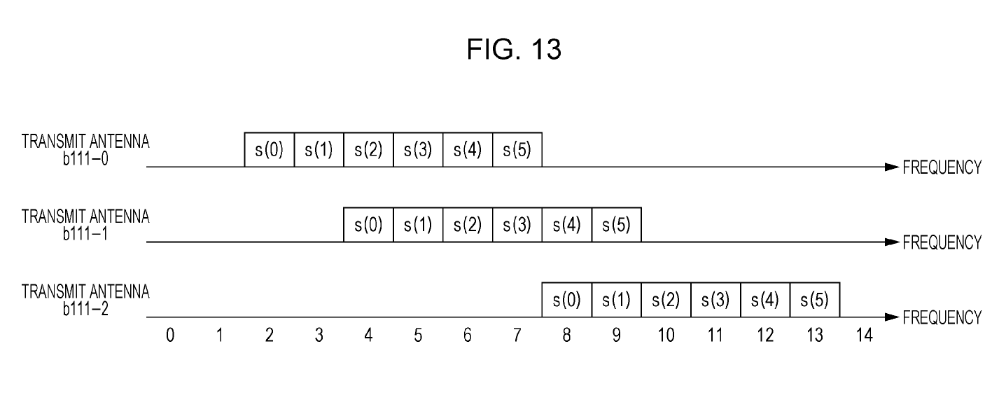

FIG. 13 is a schematic diagram illustrating another example of allocation of the frequency spectra according to the present embodiment. This diagram is a diagram for the case where Nₜ=3. In FIG. 13, for the transmit antenna b211-0, the frequency spectra s(0) to s(5) are allocated to the frequency points 2 to 7, respectively. For the transmit antenna b211-1, the frequency spectra s(0) to s(5) are allocated to the frequency points 4 to 9, respectively. For the transmit antenna b211-2, the frequency spectra s(0) to s(5) are allocated to the frequency points 8 to 13, respectively.

In other words, the mapping unit b208-0 places the signals s(0) to s(5) at the frequency points 1 to 6, respectively. The mapping unit b208-1 places the signals s(0) to s(5) at the frequency points 4 to 9, respectively. The mapping unit b208-2 places the signals s(0) to s(5) at the frequency points 8 to 13, respectively.

Note that the mobile station apparatus b2 according to the present embodiment may perform allocation illustrated in FIG. 4 or 5. For example, the mobile station apparatus b2 may select any allocation from an allocation illustrated in FIG. 4 or 5 and an allocation illustrated in FIG. 11, 12, or 13.

<Regarding Base Station Apparatus a2>

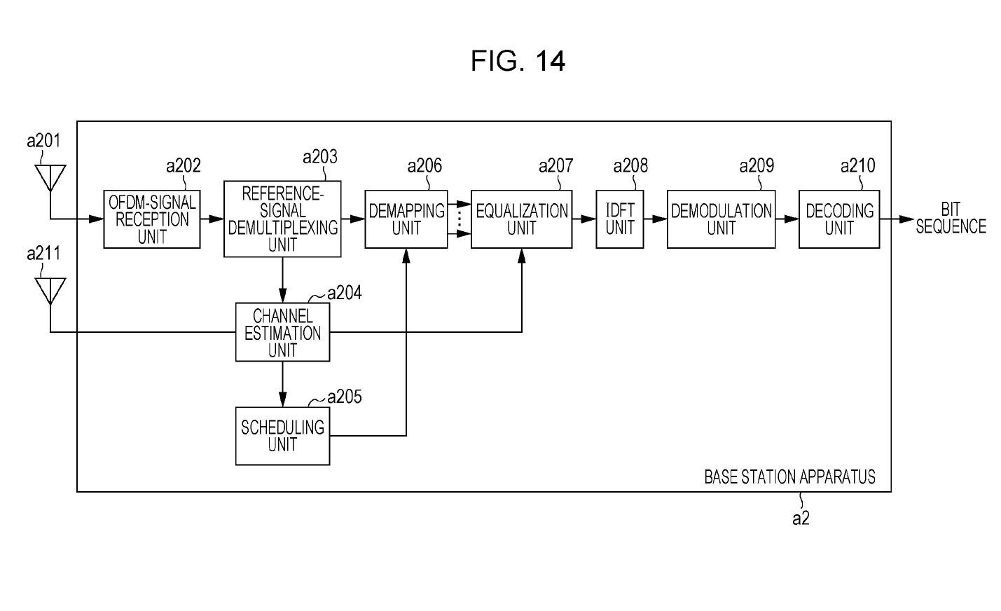

FIG. 14 is a schematic block diagram illustrating a configuration of the base station apparatus a2 according to the present embodiment. In this diagram, the base station apparatus a2 includes a receive antenna a201, an OFDM-signal reception unit a202, a reference-signal demultiplexing unit a203, a channel estimation unit a204, a scheduling unit a205, a demapping unit a206, an equalization unit a207, an IDFT (Inverse Discrete Fourier Transform) unit a208, a demodulation unit a209, a decoding unit a210, and a transmit antenna a211 (not illustrated in FIG. 9). Note that the base station apparatus a2 includes, in addition, typical and well-known functions of a base station apparatus. Note that, although the number of receive antennas is “one” in the present embodiment, the present invention is not limited thereto. The base station apparatus a2 may have multiple receive antennas, and, using well-known techniques, may obtain a receive diversity gain or improve a capability of demultiplexing signals in MIMO.

The OFDM-signal reception unit a202 performs, on signals received via the receive antenna a201, a process of downconverting from carrier frequencies to base band signals, an analog filtering process, and an A/D (analog-to-digital) conversion process. The OFDM-signal reception unit a202 removes, for each SC-FDMA symbol, a CP from the signals that have been subjected to the processes. The OFDM-signal reception unit a202 performs fast Fourier transform of the N_{FFT} points on the signals which are constituted by SC-FDMA symbols and from which CPs have been removed, thereby converting from the signals from time-domain signals to frequency-domain signals. The OFDM-signal reception unit a202 outputs, to the reference-signal demultiplexing unit a203, the signals that have been subjected to the processes.

The reference-signal demultiplexing unit a203 demultiplexes the signals, which have been input from the OFDM-signal reception unit a202, into SRSs, DMRSs, and data signals. The reference-signal demultiplexing unit a203 outputs the SRSs and DMRSs, which have been obtained by the demultiplexing, to the channel estimation unit a204, and outputs the data signals to the demapping unit a206.

The channel estimation unit a204 obtains, using the DMRSs input from the reference-signal demultiplexing unit a203, channel estimation values (phases and amplitudes) that are channel estimation values for wireless channels between the individual transmit antennas b211-0 to b211-Nₜ−1 of a certain one of the mobile station apparatuses b2 and the receive antenna a201 and that are channel estimation values for a transmission band for the data signals. The channel estimation unit a204 outputs the channel estimation values, which have been obtained using the DMRSs, to the equalization unit a206.

Furthermore, the channel estimation unit a204 estimates, using the SRSs input from the reference-signal demultiplexing unit a203, channel quality (power or amplitudes) that is channel quality for the wireless channels between the individual transmit antennas b211-0 to b211-Nₜ−1 of the mobile station apparatus b2 and the receive antenna a201 and that is channel quality for an entire system band. The channel estimation unit a204 outputs the channel quality, which has been obtained using the SRSs, to the scheduling unit a205.

The scheduling unit a205 determines, on the basis of the channel quality input from the channel estimation unit a204, allocation information indicating allocation of frequencies to the signals in the individual mobile station apparatuses b2. For example, the scheduling unit a205 determines allocation information so that, for each of the transmit antennas b211-nₜ of each of the mobile station apparatuses b2, a frequency at which the channel quality is the highest is allocated to a signal for the mobile station apparatus b2. The scheduling unit a205 stores the determined allocation information (e.g., the example illustrated in FIG. 3). Furthermore, the scheduling unit a205 determines a modulation scheme and a coding rate on the basis of the channel quality.

The scheduling unit a205 outputs the stored allocation information to the demapping unit a206 and the equalization unit a207. Moreover, the scheduling unit a205 generates control information that includes the stored allocation information, and the determined modulation scheme and coding rate, and performs coding and modulation on the generated control information. The scheduling unit a205 transmits a signal representing the modulated control information via the transmit antenna a211.

The demapping unit a206 extracts, for each of the signals s(m), signals r(p) at individual frequency points p associated with the signal s(m) from the data signals, which have been input from the reference-signal demultiplexing unit a203, on the basis of the allocation information input from the scheduling unit a205. The details of an extraction method will be described below. The demapping unit a206 outputs the extracted signals r(p) to the equalization unit a207.

The equalization unit a207 performs an equalization process on the signals r(p), which have been input from the demapping unit a206, on the basis of the allocation information, which has been input from the scheduling unit a205, and the channel estimation values, which have been input from the channel estimation unit b107. The details of the equalization process will be described below together with a configuration of the equalization unit a207. The equalization unit a207 outputs, to the IDFT unit a208, signals s′(m) that have been obtained by the equalization process.

The IDFT unit a208 performs inverse discrete Fourier transform of the N_{DFT} points on the signals input from the equalization unit a207, thereby converting the signals from frequency-domain signals to time-domain signals. The IDFT unit a208 outputs, to the demodulation unit a209, signals that have been obtained by the transform.

The demodulation unit a209 demodulates, using the modulation scheme determined by the scheduling unit a205, the signals input from the IDFT unit a208. The demodulation unit a209 outputs, to the decoding unit a210, coded bits that have been obtained by demodulating the signals.

The decoding unit a210 performs error correction decoding on the coded bits, which have been input from the demodulation unit a209, on the basis of the coding rate determined by the scheduling unit a205. The decoding unit a210 outputs a decoded bit sequence to the decoding unit a210.

<Regarding Demapping Unit a206>

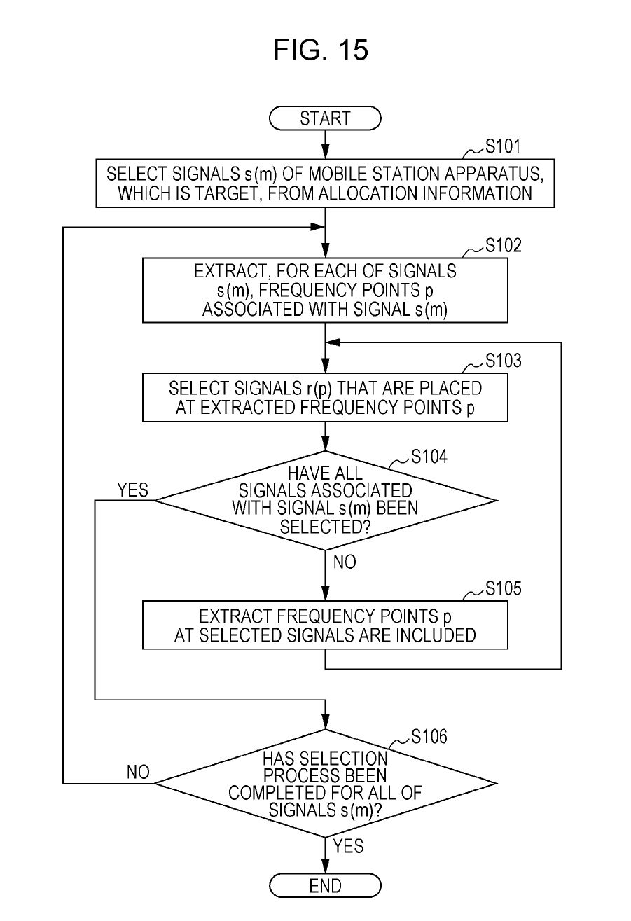

FIG. 15 is a flowchart illustrating an example of a selection process for each of the signals s(m), which is performed by the demapping unit a206 according to the present embodiment.

(Step S101) The demapping unit a206 selects, from the allocation information, signals s(m) of a mobile station apparatus b2, which is a target, among the mobile station apparatuses b2. Then, the demapping unit a206 proceeds to step S102.
(Step S102) The demapping unit a206 extracts, for each of the signals s(m) selected in step S101, frequency points p associated with the signal s(m). Then, the demapping unit a206 proceeds to step S103.
(Step S103) The demapping unit a206 selects signals r(p) that are placed at the frequency points p extracted in steps S102 and S105. Then, the demapping unit a206 proceeds to step S104.
(Step S104) The demapping unit a206 selects, using the allocation information, signals s(m) associated with the signals r(p) selected in step S103. The demapping unit a206 determines whether or not frequency points p at which the selected signals s(m) are included are included in the frequency points p extracted in steps S102 and S105. Accordingly, the demapping unit a206 determines whether or not all signals associated with each of the signals s(m) have been selected. When the demapping unit a206 determines that a signal which has not been selected is present (NO), the demapping unit a206 proceeds to step S105. In contrast, when the demapping unit a206 determines that all signals associated with each of the signals s(m) have been selected (YES), the demapping unit a206 proceeds to step S106.
(Step S105) The demapping unit a206 extracts, using the allocation information, the frequency points p associated with the signals r(p) selected in step S103. Then, the demapping unit a206 returns to step S103.
(Step S106) The demapping unit a206 determines whether or not the processes of steps S102 to S105 have been completed for all of the signals s(m). When the demapping unit a206 determines that the processes have been completed, the demapping unit a206 finishes the operation thereof. In contrast, the demapping unit a206 determines that the processes have not been completed (a signal s(m) which has not been processed is present), the demapping unit a206 returns to step S102.

As described above, the demapping unit a206 not only selects signals r(p) at frequency points p at which a signal s(m) that is a target has been transmitted, but also selects signals s(m) that have been transmitted at the same frequency points at which the signal s(m) that is a target has been transmitted and also selects signals r(p) at frequency points p at which the selected signals s(m) have been transmitted. The demapping unit a206 inputs, to the equalization unit, all received signals that have been selected.

Hereinafter, the selection process, which is performed by the demapping unit a206, of selecting spectra for each of the signals s(m) will be described using, as an example, the selection process for the signal s(0) in the case of partially overlapping. Note that, although the selection process for the signal s(0) is described below, the demapping unit a206 performs, similarly for the other signals s(m), the selection process for each of the signals s(m).

4) Case of example of allocation illustrated in FIG. 11 (allocation information illustrated in FIG. 3)

The demapping unit a206 extracts the frequency points “1” and “5” at which the signal s(0) is placed (step S102), and selects signals r(1) and r(5) (S103). The demapping unit a206 selects the signal s(0), and the signals s(0) and s(4) that are associated with the signals r(1) and r(5), respectively (see FIG. 11), and determines that the signal s(4) which has not been selected is present (step S104). The demapping unit a206 extracts the frequency point “9” associated with the selected signal s(4) (step S105, see FIG. 11), and selects a signal r(9) at the frequency point “9”. The demapping unit a206 eventually selects the signals r(1), r(5), and r(9), and determines that all signals associated with the signal s(0) have been selected (YES in step S104).

5) Case of example of allocation illustrated in FIG. 12

The demapping unit a206 extracts the frequency points “2” and “3” at which the signal s(0) is placed (step S102), and selects signals r(2) and r(3) (S103). Then, the demapping unit a206 extracts the frequency point “4” associated with the signal s(1) of the signal r(3) (step S105, see FIG. 12), and selects a signal r(4) at the frequency point “4”. Then, the demapping unit a206 extracts the frequency point “5” associated with the signal s(2) of the signal r(3) (step S105), and selects a signal r(5) at the frequency point “5”. Then, the demapping unit a206 eventually selects the signals r(4) to r(8) (S105), and determines that all signals associated with the signal s(0) have been selected (YES in step S104).

6) Case of example of allocation illustrated in FIG. 13

The demapping unit a206 extracts the frequency points “2”, “4”, and “8” at which the signal s(0) is placed (step S102), and selects signals r(2), r(4), and r(8) (S103). Then, the combining unit a2071 extracts the frequency points “4”, “6”, and “10” associated with the signal s(2) of the signal r(4), and the frequency points “6”, “8”, and “12” associated with the signal s(4) of the signal r(8) (step S105, see FIG. 12). The demapping unit a206 selects the signals r(6), r(8), r(10), and r(12) at the frequency points “6”, “8”, “10”, and “12”. The demapping unit a206 selects the signals r(2), r(4), r(6), r(8), r(10), and r(12) (S105), and determines that all signals associated with the signal s(0) have been selected (YES in step S104).

The demapping unit a206 inputs all of the selected r(p) to the equalization unit.

<Regarding Equalization Unit a207>

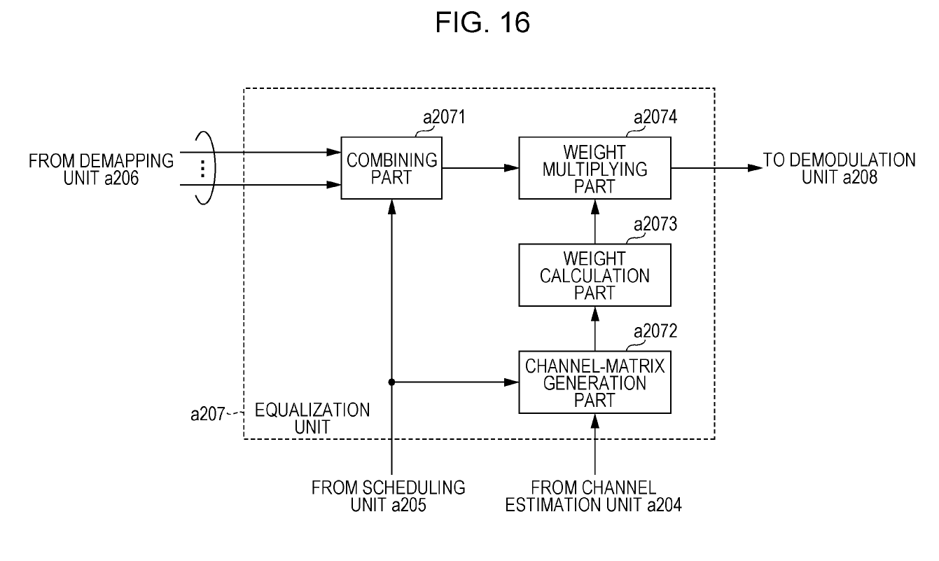

FIG. 16 is a schematic block diagram illustrating a configuration of the equalization unit a207 according to the present embodiment. In this diagram, the equalization unit a207 is configured so as to include the combining part a2071, a channel-matrix generation part a2072, a weight calculation part a2073, and a weight multiplying part a2074.

The combining part a2071 generates, on the basis of the allocation information input from the scheduling unit a205, a vector Rₘ from the signals r(p) that have been selected for each of the signals s(m). Here, m of the vector Rₘ, indicates a frequency point m of a signal s(m) associated with a signal r(p) that is selected by the selection process for each of the signals s(m). For example, in “4) case of example of allocation illustrated in FIG. 11” which is described above, the vector Rₘ is denoted by a vector R_{0, 4}.

The combining part a2071 outputs the generated vector Rₘ to the weight multiplying part a2074.

The channel-matrix generation part a2072 generates a channel matrix for each of the signals s(m) on the basis of the allocation information, which has been input from the scheduling unit a205, and the channel estimation values, which have been input from the channel estimation unit a204.

Specifically, the channel-matrix generation part a2072 selects, for each of the signals s(m), frequency points p of the signals r(p) selected by the selection process for each of the signals s(m), and channel estimation values (denoted by Hₙₜ (p)) for the antenna numbers nₜ from which signals s(m) associated with the signals r(p) have been transmitted. The channel-matrix generation part a2072 generates a channel matrix Hₘ that is constituted by the selected channel estimation values Hₙₜ(p). Note that m of the channel matrix Hₘ indicates a frequency point m of a signal s(m) associated with a signal r(p) that is selected by the selection process for each of the signals s(m). For example, in “4) case of example of allocation illustrated in FIG. 11” which is described above, the channel matrix Hₘ is denoted by a channel matrix H_{0,4}. The channel-matrix generation part b1092 outputs the generated channel matrix Hₘ to the weight calculation part a2073.

The weight calculation part a2073 calculates, using the channel matrix Hₘ input from the channel-matrix generation part a2072, a weight vector wₘ by using Expression (12) given below. Note that m of the weight vector wₘ indicates a frequency point m of a signal s(m) associated with a signal r(p) that is selected by the selection process for each of the signals s(m). For example, in “4) case of example of allocation illustrated in FIG. 11” which is described above, the weight vector wₘ is denoted by a weight vector w_{0, 4}.

[Math. 11]

wₘ=Hₘ^{H}(HₘHₘ^{H}+σ²I)⁻¹ (12)

Here, σ² is average noise power, and I is an identity matrix. Note that the average noise power σ² is calculated by a noise estimation part (not illustrated), and is input to the weight calculation part a2073.

The weight calculation part a2073 outputs the calculated weight vector wₘ to the weight multiplying part a2074. Note that, although the weight calculation part a2073 calculates the weight vector Wₘ by using Expression (12) using MMSE (Minimum Mean Square Error), the present invention is not limited thereto. For example, the weight calculation part a2073 may calculate the MIMO weight vector wₘ by using a weight of another criterion such as ZF (Zero Forcing) in which the average noise power is not taken into consideration. Additionally, the equalization process performed by the equalization unit a207 may be a process using another signal demultiplexing method such as an iterative equalization process or MLD.

The weight multiplying part a2074 multiplies the signal vector Rₘ, which has been input from the combining part a2071, by the weight vector wₘ, which has been input from the weight calculation part a2073. Accordingly, the base station apparatus a2 can obtain signals s′(m) corresponding to the signals s(m). The weight multiplying part a2074 outputs, to the IDFT unit a208, the signals s′(m) which have been obtained by the multiplication by the weight vectors.

Hereinafter, an example of an operation performed by the equalization unit a207 will be described.

4) Case of example of allocation illustrated in FIG. 11 (allocation information illustrated in FIG. 3)

The signals r(1), r(5), and r(9) that have been selected by the demapping unit a206 for the signal s(0) are represented, using the channel estimation values Hₙₜ(p) and the signals s(m) by Expression (13) given below.

$$\begin{matrix}[ Math . 12 ] & \\ \{ \begin{matrix}r ( 1 ) = {H}_{0} ( 1 ) s ( 0 ) \\ r ( 5 ) = {H}_{0} ( 5 ) s ( 4 ) + {H}_{1} ( 5 ) s ( 0 ) \\ r ( 9 ) = {H}_{1} ( 9 ) s ( 4 )\end{matrix} & ( 13 )\end{matrix}$$

Note that Expression (13) is an expression in the case where noise in the base station apparatus a2 and interference from other communication apparatuses is ignored. Here, although Expression (13) represents signals r(p) received at three frequency points, it can be considered that the signals r(p) have been received by three receive antennas. For this reason, the combining part a2071 included in the equalization unit a207 combines signals for the individual reception frequency points p with each other to generate 3×1 (three rows by one column) vector R_{0,4}. The vector R_{0,4} is represented by Expression (14) given below.

$$\begin{matrix}[ Math . 13 ] & \\ \begin{matrix}{R}_{0 , 4} = [ \begin{matrix}r ( 1 ) \\ r ( 5 ) \\ r ( 9 )\end{matrix} ] \\ = [ \begin{matrix}{H}_{0} ( 1 ) s ( 0 ) \\ {H}_{0} ( 5 ) s ( 4 ) + {H}_{1} ( 5 ) s ( 0 ) \\ {H}_{1} ( 9 ) s ( 4 )\end{matrix} ] \\ = [ \begin{matrix}{H}_{0} ( 1 ) & 0 \\ {H}_{1} ( 5 ) & {H}_{0} ( 5 ) \\ 0 & {H}_{1} ( 9 )\end{matrix} ] [ \begin{matrix}s ( 0 ) \\ s ( 4 )\end{matrix} ] \\ = {H}_{0 , 4} {s}_{0 , 4}\end{matrix} & ( 14 )\end{matrix}$$

The combining part a2071 outputs the vector R_{0,4} to the weight multiplying part a2074.

Meanwhile, the channel-matrix generation part a2072 calculates a channel matrix H_{0,4}, using the channel estimation values, which have been input from the channel estimation unit a204, and the allocation information, which has been input from the scheduling unit, and outputs the calculated matrix to the weight calculation part a2073. The weight calculation part a2073 calculates a weight vector w_{0,4} represented by Expression (15) given below.

[Math. 14]

w_{0,4}=H_{0,4}^{H}(H_{0,4}H_{0,4}^{H}+σ²I)⁻¹ (15)

Note that the equalization unit a207 outputs, to the weight multiplying part a2074, the vector R_{0,4} in which not only signals r(p) associated with a signal s(m) but also a related signal is taken into consideration. Accordingly, the weight calculation part a2073 generates the weight vector w_{0,4} that also includes elements which are to be used in equalization of the related signal (the signal s(4)).

As described above, the equalization unit a207 generates a weight vector in which not only a frequency point m at which a signal s(m) that is a target has been transmitted but also a frequency point at which a related signal has been transmitted are is taken into consideration, and performs a process, whereby the accuracy with which signals are demultiplexed in MIMO can be improved.

Furthermore, the equalization unit a207 may select combinations of vectors Rₘ so that all frequency points p at which a signal s(m) is placed are included, and may perform only processes for the combinations of vectors Rₘ and may not necessarily perform processes for the other vectors Rₘ. In this case, the equalization unit a207 may generate and compute only channel matrices Hₘ and weight vectors wₘ that correspond to the selected combinations of vectors Rₘ, and may not necessarily generate and compute channel matrices Hₘ and weight vectors wₘ other than those. In other words, the equalization unit a207 can reduce the number of times the generating process and computing process associated with channel matrices Hₘ and weight vectors wₘ are performed and, consequently, the amount of calculation performed in circuits can be reduced. Moreover, the individual parts of the equalization unit a207 may select m so that the number of combinations of vectors Rₘ is minimized.

For example, in the present example, it is only necessary for the equalization unit a207 to perform processes for vectors R_{0,4}, R_{1,5}, R₂, and R₃, and the equalization unit a207 may not necessarily perform processes for vectors R₄ and R₅. As described above, the equalization unit a207 can perform the equalization process for the multiple signals s(0) and s(4) simply by calculating one weight that is the weight vector w_{0,4} (performing inverse-matrix computation once). Thus, the amount of calculation performed in circuits can be reduced, compared with that in the case where weight vectors wₛ₍ₘ₎(wₛ₍₀₎, wₛ₍₄₎) are calculated for each of the signals s(m).

The weight multiplying part a2074 multiplies the vector R_{0,4}, which has been input from the combining part a2071, by the weight vector w_{0,4}, which has been input from the weight calculation part a2073. Signals s′(m) that have been obtained by the multiplication are represented by Expression (16) given below.

$$\begin{matrix}[ Math . 15 ] & \\ [ \begin{matrix}{s}^{′} ( 0 ) \\ {s}^{′} ( 4 )\end{matrix} ] = {S}_{0 , 4}^{′} = {w}_{0 , 4} {R}_{0 , 4} & ( 16 )\end{matrix}$$

The equalization unit a207 performs processes for the vectors R_{1,5}, R₂, and R₃ in a manner similar to the manner in which the above-described process for the vectors R_{0,4} is performed.

5) Case of example of allocation illustrated in FIG. 12

The combining part a2071 generates a vector R_{0,1,2,3,4,5} for the signal s(0). The vector R_{0,1,2,3,4,5} is represented by Expression (17) given below.

$$\begin{matrix}[ Math . 16 ] & \\ \begin{matrix}{R}_{0 , 1 , 2 , 3 , 4 , 5} = [ \begin{matrix}{H}_{0} ( 2 ) & 0 & 0 & 0 & 0 & 0 \\ {H}_{1} ( 3 ) & {H}_{0} ( 3 ) & 0 & 0 & 0 & 0 \\ 0 & {H}_{1} ( 4 ) & {H}_{0} ( 4 ) & 0 & 0 & 0 \\ 0 & 0 & {H}_{1} ( 5 ) & {H}_{0} ( 5 ) & 0 & 0 \\ 0 & 0 & 0 & {H}_{1} ( 6 ) & {H}_{0} ( 6 ) & 0 \\ 0 & 0 & 0 & 0 & {H}_{1} ( 7 ) & {H}_{0} ( 7 ) \\ 0 & 0 & 0 & 0 & 0 & {H}_{1} ( 8 )\end{matrix} ] \\ [ \begin{matrix}s ( 0 ) \\ s ( 1 ) \\ s ( 2 ) \\ s ( 3 ) \\ s ( 4 ) \\ s ( 5 )\end{matrix} ] \\ = {H}_{0 , 1 , 2 , 3 , 4 , 5} {S}_{0 , 1 , 2 , 3 , 4 , 5}\end{matrix} & ( 17 )\end{matrix}$$

The combining part a2071 outputs the vector R_{0,1,2,3,4,5} to the weight multiplying part a2074. The channel-matrix generation part a2072 calculates a channel matrix H_{0,1,2,3,4,5}, and outputs the channel matrix H_{0,1,2,3,4,5} to the weight calculation part a2073. The weight calculation part a2073 calculates a weight vector w_{0,1,2,3,4,5}, which is represented by Expression (12), and outputs the weight vector w_{0,1,2,3,4,5} to the weight multiplying part a2074. The weight multiplying part a2074 multiplies the vector R_{0,1,2,3,4,5}, which has been input from the combining part a2071, by the weight vector w_{0,1,2,3,4,5}, which has been input from the weight calculation part a2073.

6) Case of example of allocation illustrated in FIG. 13

The combining part a2071 generates a vector R_{0,2,4} for the signal s(0). The vector R_{0,2,4} is represented by Expression (18) given below.

$$\begin{matrix}[ Math . 17 ] & \\ {R}_{0 , 2 , 4} = [ \begin{matrix}{H}_{0} ( 2 ) & 0 & 0 \\ {H}_{1} ( 4 ) & {H}_{0} ( 4 ) & 0 \\ 0 & {H}_{1} ( 6 ) & {H}_{0} ( 6 ) \\ {H}_{2} ( 8 ) & 0 & {H}_{1} ( 8 ) \\ 0 & {H}_{2} ( 10 ) & 0 \\ 0 & 0 & {H}_{2} ( 12 )\end{matrix} ] [ \begin{matrix}s ( 0 ) \\ s ( 2 ) \\ s ( 4 )\end{matrix} ] & ( 18 )\end{matrix}$$

The combining part a2071 outputs the vector R_{0,2,4} to the weight multiplying part a2074. The channel-matrix generation part a2072 calculates a channel matrix H_{0,2,4}, and outputs the channel matrix H_{0,2,4} to the weight calculation part a2073. The weight calculation part a2073 calculates a weight vector w_{0,2,4}, which is represented by Expression (12), and outputs the weight vector w_{0,2,4} to the weight multiplying part a2074. The weight multiplying part a2074 multiplies the vector R_{0,2,4}, which has been input from the combining part a2071, by the weight vector w_{0,2,4}, which has been input from the weight calculation part a2073.

The equalization unit a207 performs a process for a vector R_{1,3,5} in a manner similar to the manner in which the above-described process for the vector R_{0,2,4} is performed.

As described above, in the present embodiment, the equalization unit a207 extracts not only frequency points at which a spectrum that is a target has been transmitted, but also extracts, for a spectrum that has been transmitted at the same frequency point at which the spectrum that is a target has been transmitted, a frequency point at which the spectrum has been transmitted. Accordingly, in the present embodiment, in the base station apparatus a2, signals can be demultiplexed in MIMO using much more information. Thus, the accuracy with which signals are demultiplexed in MIMO is improved. Therefore, in the base station apparatus a2, transmission performances can be improved.

FIG. 17 illustrates computer simulation results of transmission performances in the present embodiment. FIG. 17 is an explanatory diagram for explaining an effect of the wireless communication system 2 according to the present embodiment. In this diagram, the horizontal axis represents SNR (Signal to Noise power Ratio), and the vertical axis represents BER (Bit Error Rate). Furthermore, solid lines indicate simulation results in the case where an equalization process (an equalization process 1) that is the equalization process according to the present embodiment is used. The equalization process (the equalization process 1) is an equalization process for the case where, for a spectrum that has been transmitted at the same frequency point at which a spectrum that is a target has been transmitted, a frequency point at which the spectrum has been transmitted is also extracted. Meanwhile, broken lines indicate simulation results in the case where an equalization process (an equalization process 2) that is the equalization process according to the first embodiment is used. The equalization process (an equalization process 2) is an equalization process for the case where only a frequency point at which a spectrum that is a target has been transmitted is extracted.

Note that, as simulation conditions, it is supposed that the number of transmit antennas Nₜ=2 is satisfied, the number of receive antennas is one, QPSK is used as a modulation scheme, a convolutional code using a constraint length of 7 is used, the coding rate is 1/2, N_{FFT}=256 is satisfied, N_{DFT}=64 is satisfied, one-tap MMSE equalization is used as an equalization method, the channels are 16-path uniform-power Rayleigh fading channels, and estimation for the channels is ideally performed. Δ denotes differences between allocation of frequencies for a zeroth transmit antenna and allocation of frequencies for a first transmit antenna. In the case where Δ=1, 63 points that are allocated overlap each other for the two transmit antennas, and, in the case where Δ=32, 32 points that are allocated overlap each other.

FIG. 17 indicates that, in the case where the equalization process 1 indicated by the solid lines is used, the bit error rate is lower and excellent performances can be obtained, compared with those in the case where the equalization process 2 is used. In other words, in the wireless communication system 2 according to the present embodiment, the accuracy with which signals are demultiplexed in MIMO can be improved, and the transmission performances can be improved, compared with those in the wireless communication system 1.

Note that, in the present embodiment, in the case where MU-MIMO in which signals are transmitted at the same frequencies from the different mobile station apparatuses b2 is used together, the equalization unit may use an existing reception technique in which other signals are demultiplexed or reduced.

### Third Embodiment

Hereinafter, a third embodiment of the present invention will be described in detail with reference to the drawings. In the present embodiment, a case where, in the case of overlapping of all frequencies, a wireless communication system places, for at least one of signals that are placed at frequencies, a different s(m) will be described.

Note that, because a schematic diagram of an example of a wireless communication system according to the present embodiment is the same as FIG. 9, a description thereof is omitted. Hereinafter, each of the mobile station apparatuses B2n illustrated in FIG. 9 is referred to as a mobile station apparatus b3, and the base station apparatus A20 is referred to as a base station apparatus a3.

<Regarding Mobile Station Apparatus b3>

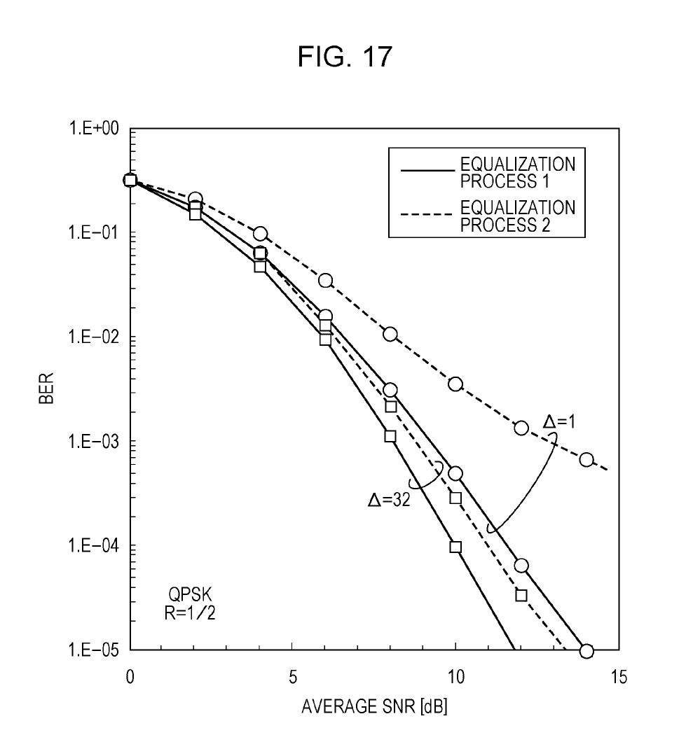

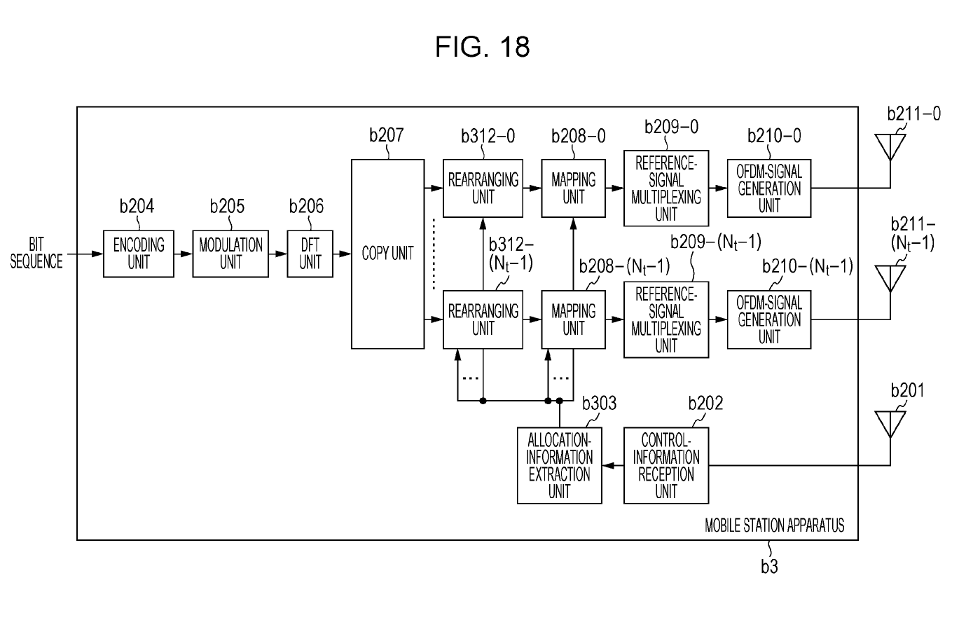

FIG. 18 is a schematic block diagram illustrating a configuration of each of the mobile station apparatuses b3 according to the third embodiment of the present invention. When the mobile station apparatus b3 (FIG. 18) according to the present embodiment and the mobile station apparatus b2 (FIG. 10) according to the second embodiment are compared with each other, the differences therebetween are an allocation-information extraction unit b303 and rearranging units b312-nₜ (nₜ=0 to Nₜ−1). However, the functions of the other elements (the receive antenna b201 (not illustrated in FIG. 9), the control-information reception unit b202, the encoding unit b204, the modulation unit b205, the DFT unit b206, the copy unit b207, the mapping units b208-nₜ, the reference-signal multiplexing units b209-nₜ, the OFDM-signal generation units b210-nₜ, and the transmit antennas b211-nₜ) are the same as those in the second embodiment. A description of the functions the same as those in the second embodiment is omitted.

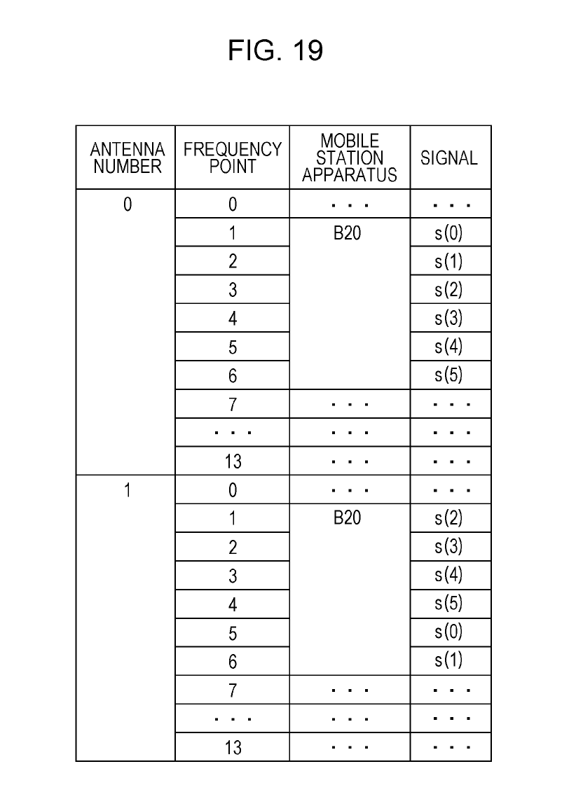

The allocation-information extraction unit b303 extracts allocation information from the control information input from the control-information reception unit b202. The allocation information indicates allocation of frequencies to the signals in the individual mapping units b208-nₜ. Here, allocation indicated by the allocation information is allocation in the case of overlapping of all frequencies, and allocation in which, for at least one of the signals that are placed at frequencies, a different s(m) is placed (e.g., an example illustrated in FIG. 19).

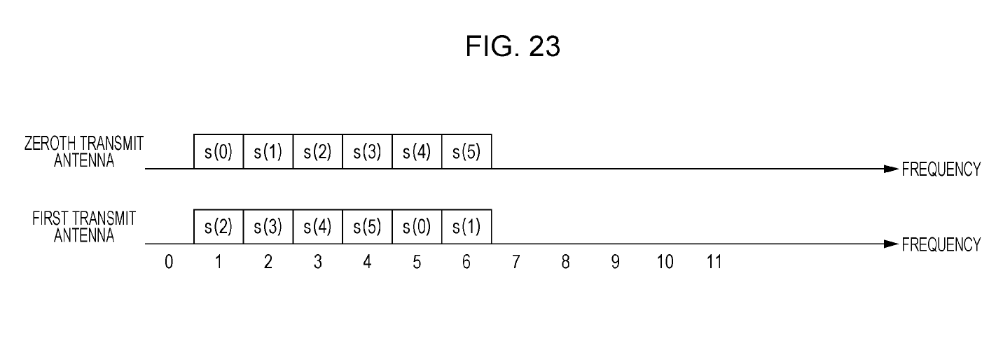

The allocation-information extraction unit b203 outputs, for each of pieces of information concerning the antenna numbers nₜ, to a corresponding one of the rearranging units b312-nₜ, allocation information indicating an arrangement order of the signals s(m) out of the extracted allocation information. Furthermore, the allocation-information extraction unit b203 outputs, to the mapping units b208-nₜ, pieces of allocation information indicating frequencies at which the signals s(m) are to be placed. Note that all of these pieces of allocation information output to the mapping units b208-nₜ is the same information (in an example illustrated in FIG. 23, information indicating the frequencies of the frequency points “1” to “6”).

Each of the rearranging units b312-nₜ rearranges the signals s(m), which have been input from the copy unit b207, so that the arrangement order of the signals s(m) is changed to an arrangement order indicated by the allocation information input from the allocation-information extraction unit b203. The rearranging units b312-nₜ output the rearranged signals to the mapping units b208-nₜ. Note that each of the mapping units b208-nₜ places the signals, which have been input from a corresponding one of the rearranging units b312-nₜ, at frequencies that are provided in the order of ascending frequency, which is indicated by the allocation information input from the allocation-information extraction unit b203, for the order in which the signals have been input. However, the present invention is not limited thereto, and it is only necessary to predetermine an order in which the signals are to be input and an order in which the signals are to be placed at frequencies.

Furthermore, the rearranging units b312-nₜ may store predetermined patterns for rearrangement, and pattern identification information by which a pattern for rearrangement is identified may be input as allocation information to each of the rearranging units b312-nₜ. In this case, the base station apparatus a3 notifies each of the mobile station apparatuses b3 of the pattern identification information as control information. Moreover, the base station apparatus a3 may notify, at every transmission opportunity, each of the mobile station apparatuses b3 of allocation information indicating an arrangement order in which the signals s(m) are to be arranged.

Additionally, each of the mobile station apparatuses b3 may notify the base station apparatus a3 of control information in which pattern identification information indicating patterns for rearrangement that is to be performed in the individual rearranging units b312-nₜ and the antenna numbers nₜ are associated with each other. In this case, the base station apparatus a3 determines placement of the signals on the basis of the control information notified from the mobile station apparatus b3.

FIG. 19 is a schematic diagram illustrating an example of the allocation information according to the present embodiment. This diagram illustrates an example of allocation information in the case where the number of antennas Nₜ=2 and the number of frequency spectra M=6. As illustrated in the diagram, the allocation information has columns of individual items that are an antenna number nₜ, a frequency point p, a mobile station apparatus, and a signal. In the allocation information, for each antenna number nₜ and each frequency point p, a corresponding one of the signals s(m) that is to be placed at the frequency point p is associated with the antenna number nₜ and the frequency point p.

For example, FIG. 19 indicates that the mapping unit b208-0 corresponding to the antenna number nₜ=0 places the signals s(2), s(5), s(4), s(3), s(0), and s(1) of the mobile station apparatus B20 illustrated in FIG. 9 at the frequency points 1, 2, 3, 4, 5, and 6, respectively. Furthermore, FIG. 19 indicates that the mapping unit b208-1 corresponding to the antenna number nₜ=1 places the signals s(2), s(3), s(4), s(5), s(0), and s(1) of the mobile station apparatus B20 at the frequency points 1, 2, 3, 4, 5, and 6, respectively.

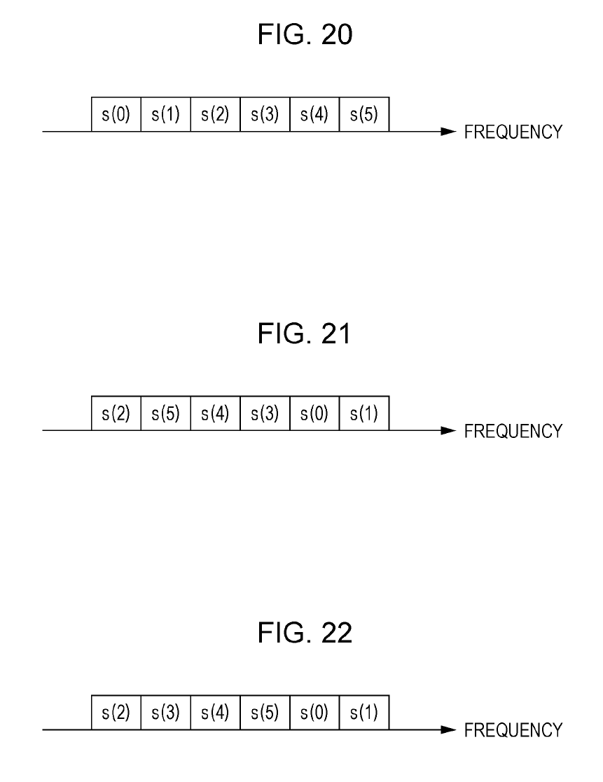

Hereinafter, rearrangement of the signals s(m), which is performed by the rearranging units b312-nₜ, will be described using FIGS. 20 to 22.

FIG. 20 is a schematic diagram illustrating the signals s(m) that are input to the rearranging units b312-nₜ according to the present embodiment. This diagram indicates that the signals s(m) are input to the rearranging units b312-nₜ in the order of the signals s(0), s(1), s(2), s(3), s(4), and s(5).

For example, in the case of the allocation information illustrated in FIG. 19, the rearranging unit b312-0 does not rearrange the input signals s(m), and outputs the signals s(m) as they are. In this case, the mapping unit b208-0 places the signals s(0), s(1), s(2), s(3), s(4), and s(5) at the frequency points provided in ascending order.

FIG. 21 is a schematic diagram illustrating examples of the signals s(m) that are output from a certain one of the rearranging units b312-nₜ according to the present embodiment. This diagram indicates that the rearranging unit b312-nₜ has rearranged the signals which have been input in the order illustrated in FIG. 20 so that the order of the signals is changed to an order illustrated in FIG. 21. Furthermore, this diagram indicates that the rearranging unit b312-nₜ outputs the signals s(m) in the order of the signals s(2), s(5), s(4), s(3), s(0), and s(1).

FIG. 22 is a schematic diagram illustrating other examples of the signals s(m) that are output from a certain one of the rearranging units b312-nₜ according to the present embodiment. This diagram indicates that the rearranging unit b312-nₜ has rearranged the signals which have been input in the order illustrated in FIG. 20 so that the order of the signals is changed to an order illustrated in FIG. 22. Furthermore, this diagram indicates that the rearranging unit b312-nₜ outputs the signals s(m) in the order of the signals s(2), s(3), s(4), s(5), s(0), and s(1).

For example, in the case of the allocation information illustrated in FIG. 19, the rearranging unit b312-1 rearranges the input signals s(m) so that the order of the signals s(m) is changed to the order illustrated in FIG. 22. In this case, the mapping unit b208-1 places the signals s(2), s(3), s(4), s(5), s(0), and s(1) at the frequency points provided in ascending order.

FIG. 23 is a schematic diagram illustrating an example of allocation of the frequency spectra according to the present embodiment. This diagram is a diagram for the case where Nₜ=2. Furthermore, the diagram indicates allocation of the frequency spectra transmitted from the transmit antennas b211-0 and b211-1 in the case of the allocation information illustrated in FIG. 19. Note that, in this case, the rearranging units b312-0 and b312-1 rearrange the signals s(m) so that the order of the signals s(m) is changed to the order illustrated in FIG. 20 and the order illustrated in FIG. 22, respectively, and outputs the signals s(m).

In FIG. 23, for the transmit antenna b211-0, the frequency spectra s(0) to s(5) are allocated to the frequency points 1 to 6, respectively. Meanwhile, for the transmit antenna b211-1, the frequency spectra s(2), s(3), s(4), s(5), s(0), and s(1) are allocated to the frequency points 1, 2, 3, 4, 5, and 6, respectively. In other words, the mapping unit b208-0 corresponding to the antenna number nₜ=0 places the frequency spectra s(0) to s(5) at the frequency points 1 to 6, respectively. Meanwhile, the mapping unit b208-1 corresponding to the antenna number nₜ=1 places the signals s(2), s(3), s(4), s(5), s(0), and s(1) at the frequency points 1, 2, 3, 4, 5, and 6, respectively.

Note that the mobile station apparatus b3 which employs SC-FDMA performs cyclic shifting on the frequency axis as in the case of rearrangement illustrated in FIG. 23, whereby the deterioration of the PAPR can be reduced, compared with that in the case of rearrangement illustrated in FIG. 22. Furthermore, the mobile station apparatus b3 may use N_{DFT}/2 as the amount of cyclic shifting in the case of rearrangement.

<Regarding Base Station Apparatus a3>

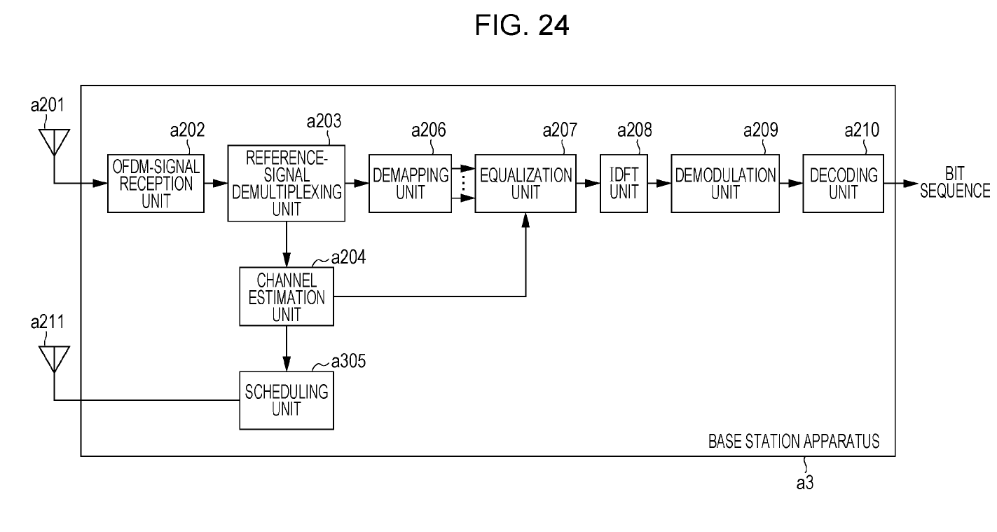

FIG. 24 is a schematic block diagram illustrating a configuration of the base station apparatus a3 according to the present embodiment. When the base station apparatus a3 (FIG. 24) according to the present embodiment and the base station apparatus a2 (FIG. 14) according to the second embodiment are compared with each other, the difference therebetween is a scheduling unit a305. However, the functions of the other elements (the receive antenna a201, the OFDM-signal reception unit a202, the reference-signal demultiplexing unit a203, the channel estimation unit a204, the demapping unit a206, the equalization unit a207, the IDFT unit a208, the demodulation unit a209, the decoding unit a210, and the transmit antenna a211) are the same as those in the second embodiment. A description of the functions the same as those in the second embodiment is omitted.

The scheduling unit a305 determines, on the basis of the channel estimate values input from the channel estimation unit a204, allocation information indicating allocation of frequencies to the signals in the individual mobile station apparatuses b3. For example, the scheduling unit a305 determines, for each of the mobile station apparatuses b2, a frequency at which the channel quality indicated by the channel estimation values is the highest. Furthermore, the scheduling unit a305 determines an arrangement order of the signals s(m) that are to be placed at the determined frequencies, and stores allocation information (e.g., the example illustrated in FIG. 19) that indicates the determined frequencies and the arrangement order. Note that, in the case where the scheduling unit a305 is notified of pattern identification information from a certain one of the mobile station apparatuses b3, the scheduling unit a305 may determine the arrangement order to be an arrangement order indicated by the pattern identification information.

Moreover, the scheduling unit a305 determines a modulation scheme and a coding rate on the basis of the channel estimation values. The scheduling unit a305 outputs the stored allocation information to the demapping unit a206 and the equalization unit a207. Additionally, the scheduling unit a305 generates control information that includes the stored allocation information, and the determined modulation scheme and coding rate, and performs coding and modulation on the generated control information. The scheduling unit a305 transmits signals representing the modulated control information via the transmit antenna a211.

Hereinafter, an example of an operation performed by the equalization unit a207 will be described. In the case of the example of allocation illustrated in FIG. 23 (the allocation information illustrated in FIG. 19), the equalization unit a207 performs the following operation.

For example, the signals r(2), r(4), r(6) that have been selected by the demapping unit a206 for the signal s(1) are represented, using the channel estimation values Hₙₜ(p) and the signals s(m), by Expression (19) given below.

$$\begin{matrix}[ Math . 18 ] & \\ \{ \begin{matrix}r ( 2 ) = {H}_{0} ( 2 ) s ( 1 ) + {H}_{1} ( 2 ) s ( 3 ) \\ r ( 4 ) = {H}_{0} ( 4 ) s ( 3 ) + {H}_{1} ( 4 ) s ( 5 ) \\ r ( 6 ) = {H}_{0} ( 6 ) s ( 5 ) + {H}_{1} ( 6 ) s ( 1 )\end{matrix} & ( 19 )\end{matrix}$$

Note that Expression (19) is an expression in the case where noise in the base station apparatus a2 and interference from other communication apparatuses is ignored. R_{1, 3, 5} generated by the combining part a2071 is represented by Expression (20) given below.

$$\begin{matrix}[ Math . 19 ] & \\ \begin{matrix}{R}_{1 , 3 , 5} = [ \begin{matrix}r ( 2 ) \\ r ( 4 ) \\ r ( 6 )\end{matrix} ] \\ = [ \begin{matrix}{H}_{0} ( 2 ) s ( 1 ) + {H}_{1} ( 2 ) s ( 3 ) \\ {H}_{0} ( 4 ) s ( 3 ) + {H}_{1} ( 4 ) s ( 5 ) \\ {H}_{0} ( 6 ) s ( 5 ) + {H}_{1} ( 6 ) s ( 1 )\end{matrix} ] \\ = [ \begin{matrix}{H}_{0} ( 2 ) & {H}_{1} ( 2 ) & 0 \\ 0 & {H}_{0} ( 4 ) & {H}_{1} ( 4 ) \\ {H}_{1} ( 6 ) & 0 & {H}_{0} ( 6 )\end{matrix} ] [ \begin{matrix}S ( 1 ) \\ S ( 3 ) \\ S ( 5 )\end{matrix} ] \\ = {H}_{1 , 3 , 5} {S}_{1 , 3 , 5}\end{matrix} & ( 20 )\end{matrix}$$

The combining part a2071 outputs the vector R_{1,3,5} to the weight multiplying part a2074.

Meanwhile, the channel-matrix generation part a2072 calculates a channel matrix H_{1,3,5}, and outputs the channel matrix H_{1,3,5} to the weight calculation part a2073. The weight calculation part a2073 calculates a weight vector w_{1,3,5} represented by Expression (21) given below.

[Math. 20]

w_{1,3,5}=H_{1,3,5}^{H}(H₁₃₅H_{1,3,5}^{H}+σ²I)⁻¹ (21)

As described above, in the present embodiment, the mobile station apparatus b3 rearranges spectra so that the individual spectra will be transmitted at different frequencies, and transmits the spectra. In the base station apparatus a3, synthesis is performed on the spectra received at the different frequencies so that interference is reduced, whereby excellent transmission performances can be obtained. Furthermore, if the signals that have been transmitted from the individual transmit antennas without being rearranged are demultiplexed, in the case where the correlation between the transmit antennas is high, the accuracy with which the signals are demultiplexed decreases. However, in the present embodiment, subcarriers can be considered as receive antennas by performing rearrangement. Thus, in the case where the correlation between the frequencies is low, the signals can be demultiplexed.

### Fourth Embodiment

Hereinafter, a fourth embodiment of the present invention will be described in detail with reference to the drawings. In the present embodiment, a case where a technique (cooperative communication, CoMP (Coordinated Multiple-Point) communication), in which multiple transmission apparatuses simultaneously transmit data whose destination is a certain reception apparatus, is used will be described.

### <Regarding Wireless Communication System 4>

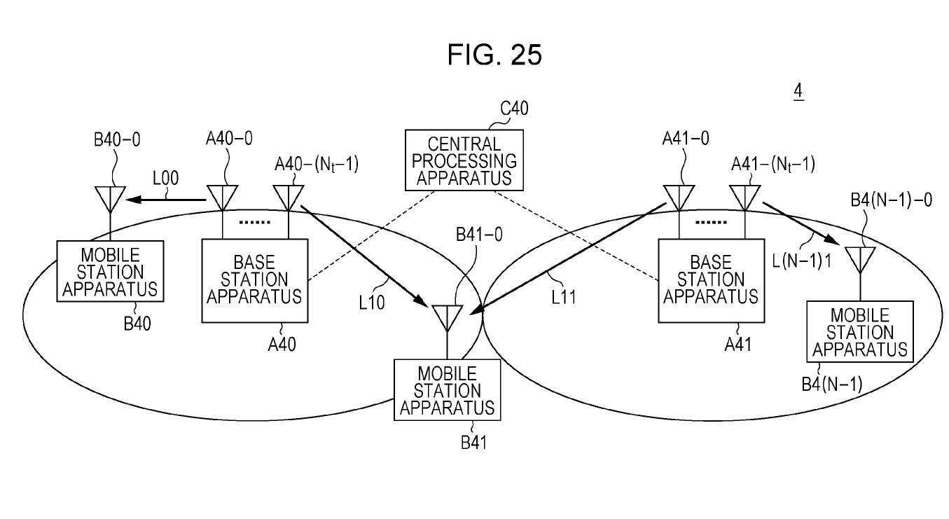

FIG. 25 is a schematic diagram illustrating an example of a wireless communication system 4 according to the fourth embodiment of the present invention. In this diagram, the wireless communication system 4 includes multiple base station apparatuses A40 and A41, N mobile station apparatuses B4n (n=0 to N−1), and a central processing apparatus C40. The base station apparatuses A40 and A41 are connected to the central processing apparatus C40 in a wired manner, for example, using optical fibers. In the case where the base station apparatuses A40 and A41 cooperatively perform downlink communication with a certain one of the mobile station apparatuses B4n, the base station apparatuses A40 and A41 share data whose destination is the mobile station apparatus B4n via the central processing apparatus C40. Note that it is only necessary for the base station apparatuses A40 and A41 to share data, and, for example, the base station apparatuses A40 and A41 may be wirelessly connected to the central processing apparatus C40 or may be directly connected to each other without the central processing apparatus C40. Furthermore, the base station apparatuses A40 and A41 do not share data whose destinations are the mobile station apparatuses B4n with which the base station apparatuses A40 and A41 do not perform corporative communication, and performs allocation (scheduling) of resources, such as frequencies/times, that are to be used for the base station apparatuses A40 and A41 to individually perform communication.

In FIG. 25, the base station apparatuses A40 and A41 have Nₜ transmit antennas A40-nₜ and Nₜ transmit antennas A41-nₜ (nₜ=0 to Nₜ−1), respectively. Note that the number of transmit antennas may be different for each of the base station apparatuses A40 and A41. Each of the mobile station apparatuses B4n has a receive antenna B4n-0.

FIG. 25 indicates that the base station apparatuses A40 and A41 perform cooperative communication with the mobile station apparatus B41, and do not perform cooperative communication with the mobile station apparatus B40 or B4(N−1). The base station apparatuses A40 and A41 are connected (using links L10 and L11, respectively) to the mobile station apparatus B41, and simultaneously transmit signals representing the same data to the mobile station apparatus B41. Moreover, the base station apparatus A40 is connected (using a link L00) to the mobile station apparatus B40, and performs communication with the mobile station apparatus B40. Independently of that, the base station apparatus A41 is connected (using a link L(N−1)1) to the mobile station apparatus B4(N−1), and performs communication with the mobile station apparatus B4(N−1).

Note that the wireless communication system 4 may include three or more base station apparatuses, and, in the wireless communication system 4, corporative communication may be performed using three or more base station apparatuses. Moreover, because the mobile station apparatuses B4n according to the present embodiment are the same as the mobile station apparatuses b1 according to the first embodiment, a description of the mobile station apparatuses B4n is omitted. However, in each of the mobile station apparatuses b1 according to the present embodiment, Nₜ transmit antennas of S base station apparatuses A41, A42, . . . , A4S (S=2 in the example illustrated in FIG. 25) are treated as S×Nₜ transmit antennas of one base station apparatus.

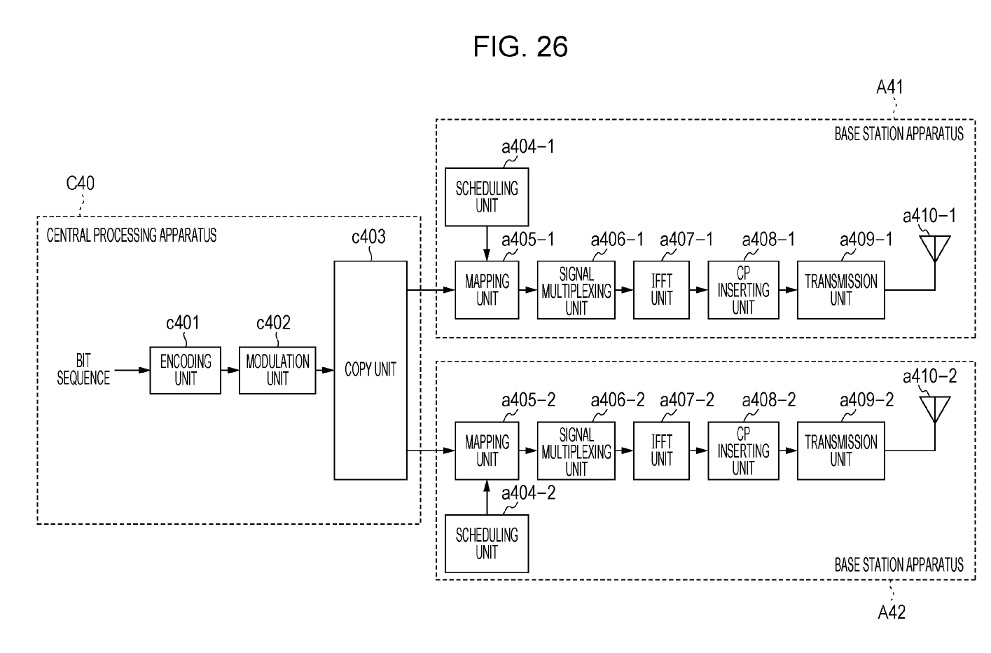

FIG. 26 is a schematic block diagram illustrating configurations of the central processing apparatus C40 and the base station apparatuses A4s (s=1, 2) according to the present embodiment. In this diagram, the central processing apparatus C40 is configured so as to include an encoding unit c401, a modulation unit c402, and a copy unit c403. Furthermore, each of the base station apparatuses A4s is configured so as to include a scheduling unit a404-s, a mapping unit a405-s, a signal multiplexing unit a406-s, an IFFT unit a407-s, a CP inserting unit a408-s, a transmission unit a409-s, and a transmit antenna a410-s. Note that, for example, in the case where the base station apparatus A4s has Nₜ transmit antennas, the base station apparatus A4s includes mapping units a405-s-nₜ (nₜ=0 to Nₜ−1), signal multiplexing units a406-s-nₜ, IFFT units a407-s-nₜ, CP inserting units a408-s-nₜ, transmission units a409-s-nₜ, and transmit antennas a410-s-nₜ.

A bit sequence, such as audio data, character data, or image data, is input to the encoding unit c401. The encoding unit c401 performs error correction coding on the input bit sequence, and outputs the error-correction-coded bits to the modulation unit c402.

The modulation unit c402 modulates the coded bits input from the encoding unit c401. The modulation unit c402 outputs, to the copy unit c403, in units of M pieces, signals which have been obtained by the modulation.

The copy unit c403 copies (duplicates) the signals s(m) input from the modulation unit c402 to generate S, which is the number of base station apparatuses that perform corporative communication, sets of the signals s(m). The copy unit c403 outputs each of the generated sets of the signals s(m) to a corresponding one of the base station apparatuses a4s.

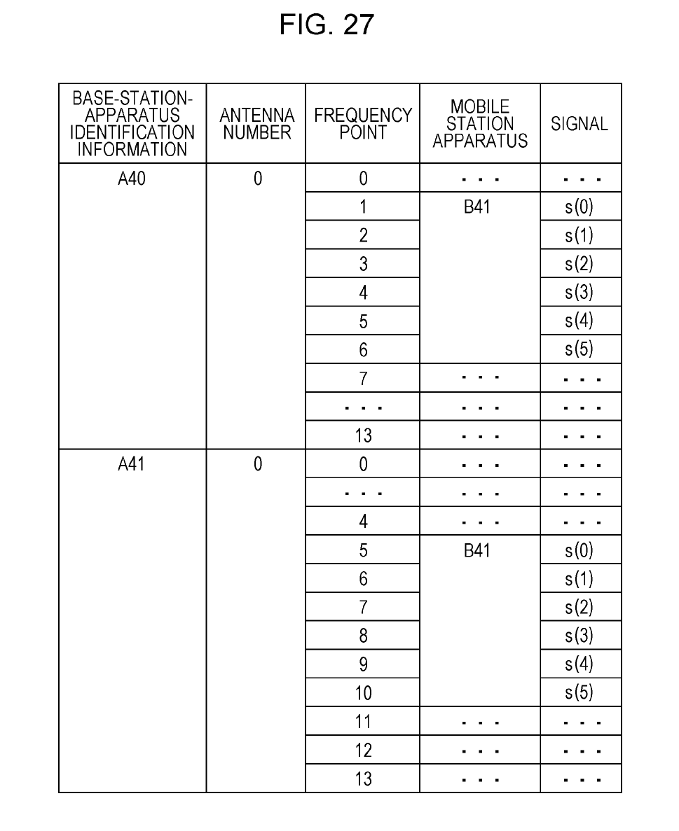

The scheduling unit a404-s stores allocation information (see FIG. 27) indicating allocation of frequencies to the signals in the mapping unit a405-s. Note that the allocation information may be information stored in advance through an operation performed by an operator or the like, or information determined by the base station apparatus a4 on the basis of a predetermined rule may be stored as the allocation information. The scheduling unit a404 outputs the stored allocation information to the mapping unit a405-s.

The mapping unit a405-s places the signals s(m), which have been input from the copy unit c403, at frequencies indicated by the allocation information input from the scheduling unit a404-s. The mapping unit a405-s outputs the frequency spectra, which have been placed, to the signal multiplexing unit a106-nₜ.

The signal multiplexing unit a406-s multiplexes the frequency spectra (also referred to as data signals) input from the mapping unit a105-s, reference signals, and control information, thereby generating a signal for transmission frames. The signal multiplexing unit a406-s outputs the generated signal for transmission frames to the IFFT unit a407-s.

The IFFT unit a407-s performs inverse fast Fourier transform of N_{FFT} points on the signal input from the signal multiplexing unit a406-s, thereby converting the signal from a frequency-domain signal to a time-domain signal. The IFFT unit a407-s outputs a signal, which has been obtained by the transform, to the CP inserting unit a408-s.

The CP inserting unit a408-s inserts, for each OFDM symbol, a CP into the signal input from the IFFT unit a407-s. The CP inserting unit a408-s outputs, to the transmission unit a409-s, the signal into which CPs have been inserted.

The transmission unit a409-s performs, on the signal input from the CP inserting unit a408-s, a D/A conversion process, an analog filtering process, and a process of upconverting from a base band to a carrier frequency. The transmission unit a409-s transmits, via the transmit antenna a410-s, the signal that has been subjected to the processes.

FIG. 27 is a schematic diagram illustrating an example of the allocation information according to the present embodiment. This diagram illustrates an example of allocation information in the case where the number of base station apparatuses that perform cooperative communication S=2, the number of antennas Nₜ=1, and the number of frequency spectra M=6. As illustrated in the diagram, the allocation information has columns of individual items that are base-station-apparatus identification information, an antenna number nₜ, a frequency point p, a mobile station apparatus, and a signal. In the allocation information, for each antenna number nₜ and each frequency point p, a corresponding one of the signals s(m) that is to be placed at the frequency point p is associated with the antenna number nₜ and the frequency point p. Note that the scheduling unit a404-s may store only allocation information in which the base-station-apparatus identification information is associated with “A4s”. The mobile station apparatus b1 stores the allocation information illustrated in FIG. 27.

For example, FIG. 27 indicates that the mapping unit a405-0 (which corresponds to the antenna number “0”) of the base station apparatus “A40” places the signals s(0) to s(5) whose destination is the mobile station apparatus B41 illustrated in FIG. 1 at frequency points 1 to 6, respectively. Furthermore, FIG. 27 indicates that the mapping unit a405-1 (which corresponds to the antenna number “0”) of the base station apparatus “A41” places the signals s(0) to s(5) whose destination is the mobile station apparatus B41 at frequency points 5 to 10, respectively.

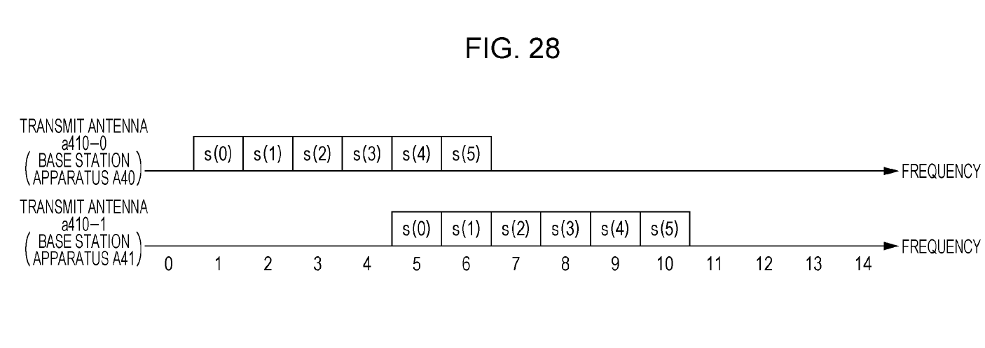

FIG. 28 is a schematic diagram illustrating an example of allocation of the frequency spectra according to the present embodiment. This diagram illustrates allocation of the frequency spectra in the case of the allocation information illustrated in FIG. 27.

In FIG. 28, for the transmit antenna a410-0 of the base station apparatus A40, the frequency spectra s(0) to s(5) are allocated to the frequency points 1 to 6, respectively. Meanwhile, for the transmit antenna a410-1 of the base station apparatus A41, the frequency spectra s(0) to s(5) are allocated to the frequency points 5 to 10, respectively. In other words, the mapping unit a405-0 places the signals s(0) to s(5) whose destination is a certain one of the mobile station apparatuses B4n at the frequency points 1 to 6, respectively. Meanwhile, the mapping unit a405-1 places the signals s(0) to s(5) whose destination is the mobile station apparatus B4n at the frequency points 5 to 10, respectively.

Note that the mobile station apparatus b1 according to the present embodiment may perform allocation illustrated in FIG. 4, 5, 11, 12, or 13.

As described above, in the present embodiment, in the system in which the multiple base station apparatuses A40 and A41 cooperatively communicate with a certain one of the mobile station apparatuses b11, cooperative communication can be performed without performing allocation in such a manner that the base stations have the same allocation of resources. The mobile station apparatus b1, which is a receiver, performs a process of demultiplexing signals, while taking into consideration the fact that the same spectrum is received at multiple frequencies. As a result, restrictions on scheduling performed for the mobile station apparatuses b1 for which corporative communication is not performed can be reduced. Thus, an excellent cell throughput (a system throughput) can be achieved.

Note that, although a case where spectra are contiguously allocated has been described in each of the foregoing embodiments, the present invention may be applied to a case where spectra are non-contiguously allocated. Furthermore, in the case where MU-MIMO (Multi-User Multiple Input Multiple Output), in which signals whose destinations are different users are transmitted at the same frequencies from the different transmit antenna a110-nₜ or a410-s, is used together, the equalization unit uses an existing reception technique in which other signals are demultiplexed by or reduced. Moreover, although, in the foregoing first embodiment, the present invention has been described using OFDM as an example, the present invention may also be applied to single carrier transmission as in the second and third embodiments. However, in this case, it is preferable that the weights included in Expression (1) be calculated not using MRC as a criterion but using MMSE as a criterion. However, even in the case, inverse-matrix computation is not necessary. Additionally, although a case where the same spectrum is transmitted using multiple subcarriers is described in the present embodiment, the present invention is not limited to a case where frequencies (subcarriers) are used as multiple resources, and anything, for example, times, may be used as multiple resources. For example, in the case of an ARQ (Automatic Repeat reQuest), for certain signals, received signals in the case where the certain signals have been first transmitted and received signals in the case where the certain signals have been transmitted again may be considered as signals received by different antennas, or, in CDMA, individual codes may be considered as different receive antennas.

Note that each of the mobile station apparatuses b1 according the above-described first embodiment may include the demapping unit a206 and the equalization unit a207 instead of the demapping unit a206 and the equalization unit b109. Furthermore, the base station apparatus a1 may include the rearranging units b312-nₜ. For example, the rearranging units b312-nₜ rearrange, on the basis of the allocation information input from the scheduling unit a104, the signals input from the copy unit a103, and output the rearranged signals to the mapping units a105-nₜ.

Moreover, the base station apparatus a2 according to the second embodiment may include the demapping unit b108 and the equalization unit b109 instead of the demapping unit a206 and the equalization unit a207.

Note that a portion of each of the base station apparatuses a1 to a4, the mobile station apparatuses b1 to b3, and the central processing unit C40 in the above-described embodiments may be realized by a computer. In this case, a program for realizing the control function thereof is recorded onto a computer-readable recording medium, and the program recorded on this recording medium is read and executed by a computer system, whereby the portion thereof may be realized. Note that the term “computer system” used herein may refer to a computer system that is built into in each of the base station apparatuses a1 to a4, the mobile station apparatuses b1 to b3, and the central processing unit C40, and may include an OS and hardware such as peripheral devices. Moreover, the term “computer-readable recording medium” refers to a portable medium such as a flexible disk, a magneto-optical disk, a ROM, or a CD-ROM, or a storage device, such as a hard disk, that is built into a computer system. Additionally, the term “computer-readable recording medium” may include a medium that dynamically holds a program in a short period of time, such as a communication line in the case where a program is transmitted via a network such as the Internet or a communication line such as a telephone line, and a medium that holds the program in a fixed period of time, such as a volatile memory included in a computer system which serves as a server or client in such a case. Furthermore, the above-mentioned program may be a program for realizing a portion of the above-mentioned function, and may also be a program that can realize the above-mentioned function in combination with a program that is already recorded in the computer system.

Moreover, a portion or the entirety of each of the base station apparatuses a1 to a4, the mobile station apparatuses b1 to b3, and the central processing unit C40 in the above-described embodiments may be realized as an integrated circuit such as an LSI (Large Scale Integration). The individual functional blocks of each of the base station apparatuses a1 to a4, the mobile station apparatuses b1 to b3, and the central processing unit C40 may be individually implemented as processors, or some or all of them may be integrated and implemented as a processor. Additionally, a scheme for circuit integration is not limited to LSI, and may be realized by a dedicated circuit or a general purpose processor. Furthermore, when a technique for circuit integration as an alternative to LSI emerges because semiconductor technology progresses, an integrated circuit based on the technique may be used.

Although the embodiments of the present invention have been described in detail with reference to the drawings, specific configurations are not limited to the above-described configurations. Various design modifications or the like can be made within a scope that does not depart from the gist of the present invention.

### INDUSTRIAL APPLICABILITY

It is preferable that the present invention be used in a mobile communication system that is a wireless communication system in which mobile phones are used as mobile station apparatuses, but the present invention is not limited thereto.

### DESCRIPTION OF REFERENCE NUMERALS

A10, A20, A4s, a1, a2, a3 . . . base station apparatus, B1n, B2n, B4n, b1, b2, b3 . . . mobile station apparatus, C40 . . . central processing apparatus, A10-nₜ, A4s-nₜ, a110-nₜ, a410-s . . . transmit antenna, A20-0, a201 . . . receive antenna, B1n-0, B2n-nₜ, b101, b201 . . . receive antenna, B2n-nₜ . . . transmit antenna, a101 . . . encoding unit, a102 . . . modulation unit, a103 . . . copy unit, a104, a404-s . . . scheduling unit, a105-nₜ, a405-s . . . mapping unit, a106-nₜ, a406-s . . . signal multiplexing unit, a107-nₜ, a407-s . . . IFFT unit, a108-nₜ, a408-s . . . CP inserting unit, a109-nₜ, a409-s . . . transmission unit, . . . transmit antenna, b102 . . . reception unit, b103 . . . CP removal unit, b104 . . . FFT unit, b105 . . . signal demultiplexing unit, b106 . . . allocation-information extraction unit, b107 . . . channel estimation unit, b108 . . . demapping unit, b109 . . . equalization unit, b110 . . . demodulation unit, b111 . . . decoding unit, b1091 . . . combining part, b1092 . . . channel-matrix generation part, b1093 . . . MIMO weight calculation part, a1094 . . . SIMO weight calculation part, b1095 . . . weight multiplying part, b202 . . . control-information reception unit, b203, b303 . . . allocation-information extraction unit, b204 . . . encoding unit, b205 . . . modulation unit, b206 . . . DFT unit, b208-nₜ . . . mapping unit, b209-nₜ . . . reference-signal multiplexing unit, b210-nₜ . . . OFDM-signal generation unit, a202 . . . OFDM-signal reception unit, a203 . . . reference-signal demultiplexing unit, a204 . . . channel estimation unit, a205, a305 . . . scheduling unit, a206 . . . demapping unit, a207 . . . equalization unit, a208 . . . IDFT unit, a209 . . . demodulation unit, a210 . . . decoding unit, a211 . . . transmit antenna, a2071 . . . combining part, a2072 . . . channel-matrix generation part, a2073 . . . weight calculation part, a2074 . . . weight multiplying part, b312-nₜ . . . rearranging unit, c401 . . . encoding unit, c402 . . . modulation unit, c403 . . . copy unit

1. A wireless communication system comprising:
a transmission apparatus configured to transmit spectra from at least one first transmit antenna, and transmit, from a second transmit antenna, spectra which are the same as the spectra; and
a reception apparatus configured to receive the same spectra transmitted from the first and second transmit antennas,
wherein the transmission apparatus includes a mapping unit configured to place the spectra for each of the transmit antennas, and
wherein the reception apparatus includes an equalization unit configured to perform, for each of the same spectra, using spectra of subcarriers having the same spectrum placed therein, equalization of the spectrum.

2. The wireless communication system according to claim 1, wherein the mapping unit is configured to place the spectra so that allocation of a frequency band is different for each of the first transmit antenna and the second transmit antenna.

3. The wireless communication system according to claim 1, wherein the mapping unit is configured to place the spectra so that allocation of frequencies to the individual spectra is different for each of the first transmit antenna and the second transmit antenna.

4. The wireless communication system according to claim 3,
wherein the transmission apparatus further includes a rearranging unit configured to rearrange the spectra so that an order of the spectra is different for each of the first transmit antenna and the second transmit antenna, and
wherein the mapping unit is configured to place the spectra in the order of the spectra rearranged by the rearranging unit.

5. The wireless communication system according to claim 1, wherein the equalization unit is configured to perform, using spectra of subcarriers having the same spectrum placed therein and spectra of subcarriers having spectra, which is the same as the spectra, placed therein, equalization of the spectrum.

6. The wireless communication system according to claim 1, wherein the wireless communication system includes a transmission apparatus having the first transmit antenna and a transmission apparatus having the second transmit antenna.

7. The wireless communication system according to claim 1,
wherein the reception apparatus further includes a demapping unit that configured to extract, for each of the same spectra, spectra of subcarriers having the same spectrum placed therein, and
wherein the equalization unit is configured to perform, using the spectra extracted by the demapping unit, equalization of the spectrum.

8. The wireless communication system according to claim 1,
wherein the reception apparatus further includes a channel-matrix generation unit configured to generate, for each of the same spectra, a channel matrix for subcarriers having the spectrum placed therein, and
wherein the equalization unit is configured to perform, using the channel matrix generated by the channel-matrix generation unit, equalization of the spectrum.

9. The wireless communication system according to claim 1, wherein the equalization unit is configured to switch, in accordance with whether or not subcarriers having the same spectrum placed therein have another spectrum placed therein, a process of computing a weight that is to be used in equalization.

10. A reception apparatus comprising:
a reception unit configured to receive the same spectra transmitted from at least one first transmit antenna and a second transmit antenna; and
an equalization unit configured to perform, for each of the same spectra, using spectra of subcarriers having the same spectrum placed therein, equalization of the spectrum.

11. A reception control method for a reception apparatus, comprising:
receiving the same spectra transmitted from at least one first transmit antenna and a second transmit antenna; and
performing, with the reception apparatus, for each of the same spectra, using spectra of subcarriers having the same spectrum placed therein, equalization of the spectrum.

12. A non-statutory computer-readable medium having instructions stored therein, such that when the instructions are read and executed by a processor, the processor being configured to perform:
receiving the same spectra transmitted from at least one first transmit antenna and a second transmit antenna; and
performing, for each of the same spectra, using spectra of subcarriers having the same spectrum placed therein, equalization of the spectrum.

13. A processor comprising:
an equalization unit configured to perform, for each of the same spectra transmitted from at least one first transmit antenna and a second transmit antenna, using spectra of subcarriers having the same spectrum placed therein, equalization of the spectrum.

14. A processor comprising:
a demapping unit configured to extract, for each of the same spectra transmitted from at least one first transmit antenna and a second transmit antenna, spectra of subcarriers having the same spectrum placed therein.

15. A processor comprising:
a channel-matrix generation unit configured to generate, for each of the same spectra transmitted from at least one first transmit antenna and a second transmit antenna, a channel matrix for subcarriers having the same spectrum placed therein.
